(19) United States
(12) Patent Application Publication
(10) Pub. No.: US 2002/0180902 A1
(43) Pub. Date: Dec. 5, 2002

(54) Active matrix substrate, display device, and detector

(75) Inventors: Yoshihiro Izumi, Kashihara-shi (JP); Koichi Miyachi, Soraku-gun (JP)

Correspondence Address: Dike, Bronstein, Roberts & Cushman, Intellectual Property Practice Group, Edwards & Angell, LLP, P.O. Box 9169, Boston, MA, 02209, US

(73) Assignee: Sharp Kabushiki Kaisha

(21) Appl. No.: 10/161,490

(22) Filed: Jun. 3, 2002

(30) Foreign Application Priority Data
Jun. 5, 2001 (JP) 2001-170150
Mar. 1, 2002 (JP) 2002-56403

(51) Int. Cl. G02F 1/136

(52) U.S. Cl. 349/43

(57) ABSTRACT

An active matrix substrate according to the present invention is arranged so that: (a) a first layer having a scanning line and signal lines and (b) a second layer having pixel electrodes are separately provided, and each pixel electrode is electrically connected to a drain electrode of a corresponding TFT via a contact hole, provided between the first and second layers, which has been extended in a direction in which it crosses a flat surface of the first layer. Thus, without complicating a wiring layout of the scanning line and the signal lines, it is possible to remarkably restrain occurrence of an outstanding seam which occurs when a display panel is apparently colored like a rainbow in the vicinity of a seam between the display panels.

### FIELD OF THE INVENTION

The present invention relates to an active matrix substrate and a display device that can be used in an audio visual (AV) device and an office automation (OA) device, a public device, and an advertising display, and relates to an active matrix substrate and a detector that can be used in a surface detector capable of detecting two dimensional data of an image.

### BACKGROUND OF THE INVENTION

Recently, a display device that is used in a household TV used as an AV device, and an OA device is required to have the following advantages: light weight, thinness, low power consumption, high definition, and a wide screen.

Thus, a display device such as a CRT (cathode ray tube), a liquid crystal display (LCD), a plasma display device (PDP), an EL (electro luminescent) display device, and an LED (light emitting diode), has been being developed so as to realize a wider screen, and has been in practical use gradually. Compared with other display devices, a liquid crystal device has such advantages that: its thickness (length) can be extremely reduced, power consumption is small, and it is easy to realize full color display. Therefore, the liquid crystal display has been used in various fields recently, and is greatly required to have a wider screen.

Then, a direct-viewing-type display device is developed so as to be applied to an audio visual (AV) device, an office automation (OA) device, a public display, and an advertising display etc. Specifically, there is developed a multipanel type display device having a wider screen which is realized by connecting plural display panels constituted of active matrix substrates so that their edges are joined to each other.

On the other hand, in an active matrix drive type liquid crystal display device with high display performance, widening a screen extremely raises a rate at which defect occurs due to (a) disconnection of signal lines brought about in the manufacturing process and (b) pixel deficiency etc. Therefore, widening the screen raises such a problem that a price of the liquid crystal display device becomes higher. In order to solve the problem, plural liquid crystal display devices are combined with each other so as to form a single multidisplay type liquid crystal display device, so that a screen is widened.

For example, Japanese Unexamined Patent Publication No. 122769/1996 (Tokukaihei 8-122769)(Publication date: May 17, 1996) discloses a structure of a wide-screen-display device in which plural liquid crystal panels are connected to each other on a flat surface (see FIG. 19). Here, by employing (a) a structure in which a dead space existing in a seam between panels is made narrower by processing edges of the liquid crystal panel 102 with high accuracy so as to equalize a pixel pitch of the seam with a pixel pitch of other portions, and (b) a structure in which no light leaks from the seam between the liquid crystal panels, a multipanel structure in which the seam is not obvious is realized. In FIG. 19, 103, 104, and 105 refer to a color filter, a black matrix, and a segmentation line respectively.

Incidentally, as to an XY matrix display type display device, it is general that respective color pixels (R), (G), and (B) in a unit pixel are aligned in order in a crosswise direction (X direction) in accordance with a general data format of image data. Further, as seen in a general NTSC system display device or a high vision system display device, it is preferable that a display of the display device is long from side to side so as to realize high telepresence. Thus, also in a multipanel type display device in which plural panels are combined with each other, as shown in FIG. 20, it may be general that liquid crystal panels 102 are connected to each other only in a crosswise direction (X direction) or in both vertical and horizontal directions so as to arrange a display which is long from side to side. In FIG. 20, 108 refers to a seam line.

However, as described above, in a case where plural liquid crystal panels, each of which has the color pixels (R), (G), and (B) in a unit pixel that are aligned in order in a crosswise direction (X direction), are connected to each other, there occurs the following problem.

FIG. 21 is an oblique perspective and widened view showing a seam of a conventional multipanel type display device in which plural liquid crystal panels are connected to each other in a crosswise direction. In this case, a seam line 108 between the liquid crystal panels 102 is arranged in a vertical direction (Y direction), and a distance from the seam line 108 to the respective color pixels (R), (G) and (B) is different for each of the color pixels. As to a display device having such pixel arrangement, if the seam between the liquid crystal panels 102 is diagonally observed, a positioning relation between the respective color pixels and the seam line relatively differs depending on an observing position (observation angle). For example, depending on an observer's position (observation angle), there is a case where a seam line 108 apparently overlaps with an R (red) pixel, or there is another case where the seam line 108 apparently overlaps with a B (blue) pixel. In these cases, display color which overlaps with the seam line 108 is a little spoiled by the seam line 108, so that a coloring balance of the display color in the vicinity of the seam line 108 is disturbed. As a result, there occurs such a problem that: the vicinity of the seam is colored like a rainbow depending on the observer's position (observation angle), so that the seam between the liquid crystal panels becomes obvious.

To cope with such problem, there is proposed a multipanel type display device in which the seam between liquid crystal panels is disposed in the same direction as in the conventional ones, and only a direction in which the color pixels (R), (G), and (B) in a unit pixel are aligned is changed to a vertical direction (Y direction), in (1) Japanese Unexamined Patent Publication No. 146455/1996 (Tokukaihei 8-146455)(publication date: Jun. 7, 1996)(hereinbelow referred to as prior art 1), (2) Japanese Unexamined Patent Publication No. 186315/1998 (Tokukaihei 10-186315)(publication date: Jul. 14, 1998)(hereinbelow referred to as prior art 2), and (3) “Manufacturing of Large Wide-View Angle Seamless Tiled AMLCDs for Business and Consumer Applications” (hereinbelow referred to as prior art 3) recited on pages 191 to 194 in a conference report of the 1st International Display Manufacturing Conference (IDMC 2000).

When a liquid crystal panel having such pixel arrangement is used, in a case where plural liquid crystal panels are combined with each other in a crosswise direction, as shown in FIG. 23, a distance from the seam line 108 to the respective color pixels (R), (G), and (B) is uniformed for each of the color pixels. Thus, in a case where the seam between the panels 102 is diagonally observed, the seam line 108 overlaps with all the color pixels (R), (G), and (B) under the same condition. Therefore, even though display color is a little spoiled by the seam line 108, a coloring balance is not disturbed. As a result, it is possible to improve the conventional problem that the vicinity of the seam is colored like a rainbow depending on the observer's position (observation angle).

However, the foregoing prior arts have the following problems.

### (1) Device Recited in the Prior Art 1

As to the display device disclosed in the prior art 1, a wiring layout of an active matrix substrate as shown in FIG. 24 is used, so that this realizes a multipanel type display device wherein a direction in which the color pixels (R), (G), and (B) in a unit pixel are aligned is changed to a vertical direction (Y direction). In FIG. 24, 111, 113, 114 refer to a unit pixel, scanning lines, and signal lines respectively. The device uses such a special wiring layout that the signal lines 114 are formed around the pixel electrode so that the signal line 114 and the pixel electrode are formed on the same layer and the signal lines 114 corresponding to the respective colors are not crossed. However, as to the wiring layout shown in FIG. 24, signal lines are complicated due to the foregoing formation of the signal lines 114, so that the signal line becomes longer than required. Therefore, use of the foregoing wiring layout raises such problems that fair quality cannot be kept and time constant of the signal line increases. Particularly, for a wide area display device realized mainly by the multipanel system, the increase in the time constant of the signal line is a serious problem. Thus, there may be limitations in realizing the wide area by the foregoing wiring layout.

### (2) Device Recited in the Prior Art 2

As to the display device disclosed in the prior art 2, a wiring layout of an active matrix substrate as shown in FIG. 25 and FIG. 26 is used, so that this realizes a multipanel type display device wherein a direction in which the color pixels (R), (G), and (B) in a unit pixel are aligned is changed to a vertical direction (Y direction). In FIG. 25, 121, 123, and 124 refer to a unit pixel, scanning lines, and signal lines respectively. The device uses such a wiring layout (FIG. 25) that directions in which the signal lines 124 and the scanning lines 123 are aligned differ from a conventional ones, or such a wiring layout (FIG. 26) that the scanning lines 133 (3 lines) are provided on each pixel electrode corresponding to the colors (R), (G), and (B). However, in this case, since a basic arrangement of the signal lines and the scanning lines is different from a conventional arrangement, it is required to drive a display panel after converting format of image data, so that this raises such a problem that a conversion circuit for image data is additionally required. This can result in increasing a price of the display device.

### (3) Device Recited in the Prior Art 3

As to the display device disclosed in the prior art 3, a wiring layout of an active matrix substrate as shown in FIG. 27 is used, so that this realizes a multipanel type display device wherein a direction in which the color pixels (R), (G), and (B) in a unit pixel are aligned is changed to a vertical direction (Y direction). That is, there are provided Rows 143, Column Channels 144, Row Access Channels 145. The device uses such a wiring layout that the respective signal lines of the color pixels (R), (G), and (B) are unevenly distributed in one corner of a unit pixel. However, although a detail wiring layout is not disclosed as to the wiring layout shown in FIG. 27, it is obvious that each of signal lines cannot be connected to a related TFT (thin film transistor) unless the signal lines corresponding to the respective colors are crossed, so that a structure in which the signal lines are three-dimensionally crossed is required. Thus, there is a possibility that a forming process of the signal lines becomes complicated, so that it is required to use a wiring layout which does not require a further forming process, or requires minimum increase in the forming process.

### SUMMARY OF THE INVENTION

The present invention was created from the view point of the foregoing problems, and its object is to provide an active matrix substrate having a panel structure (wiring layout) which is the most suitable to change a disposing direction of pixels in a unit pixel and a display device using the active matrix substrate.

In order to solve the foregoing problems, the active matrix substrate of the present invention is constituted of unit pixels each of which is provided on a crossing point between a scanning line and each of signal lines in a matrix manner via each of switching elements, and the unit pixel includes pixel electrodes which conduct in combination with the signal lines that correspond to the pixel electrodes when the switching element is ON by applying a scanning signal to the scanning line, and the active matrix substrate includes (a) a first layer having the scanning line, the signal lines, and the switching element, and (b) a second layer having the pixel electrodes, aligned along a disposing direction of the signal lines, which are insulated from (i) a scanning-line-side terminal and a signal-line-side terminal of the switching element, (ii) the scanning line, and (iii) the signal lines, and the second layer is provided above the first layer, wherein between the first layer and the second layer, there is provided a connection section for electrically connecting each of the pixel electrodes to a pixel-electrode-side terminal of the switching element that corresponds to the pixel electrode.

It is possible to arrange the connection section, for example, by partially transforming a shape of a connection portion of the pixel electrode. For example, it is possible to arrange the connection section by forming a contact hole having such a shape that the connection portion of the pixel electrode caves and extends in a direction of the first layer.

Note that, it is possible to make such an arrangement that in the unit pixel, a distance between the connection sections and the scanning line is different for each of the connection sections. For example, it is possible to make such an arrangement that in the unit pixel, all the contact holes have different distances to the scanning line. Further, it is possible to make such an arrangement that, for example, the pixel electrodes are aligned along a disposing direction of the signal lines, the second direction (Y direction), so as to correspond to the respective signal lines.

It is possible to make an arrangement so that the connection section extends in a direction in which it crosses an electrode surface of the connection portion of the pixel electrode. Particularly, it is possible to make such an arrangement that, for example, the connection portion of the connection section electrically connects the pixel electrode to a pixel-electrode-side terminal of the switching element which extends so as to be positioned under the pixel electrode.

It is possible to make such an arrangement that the pixel electrodes in the unit pixel correspond to respective colors in the unit pixel. For example, it is possible to make such an arrangement that three pixel electrodes are provided in a single unit pixel, and image signals corresponding to red, blue, and green are to be applied to the pixel electrodes respectively.

It is possible to insulate (i) the scanning-line-side terminal and a signal-line-side terminal of the switching element, (ii) the scanning line, and (iii) the signal lines from the pixel electrode, for example, by providing an interlayer insulating film therebetween.

According to the arrangement, (a) a layer having the scanning line and the signal lines and (b) a layer having the pixel electrodes are separately provided, and the respective pixel electrodes are electrically connected to the corresponding pixel-electrode-side terminals of the switching element by the connection section, positioned between the first layer and the second layer, which extends in a direction in which it crosses a flat surface of the first layer.

In a case where the pixel electrodes in the unit pixel are aligned in a disposing direction of the signal lines, when (a) the layer having the scanning line and the signal lines and (b) the layer having the pixel electrodes are provided in the same layer, an extending direction of a gap between the pixel electrodes is not identical with a disposing direction of the signal lines. Therefore, in this case, it is required to provide the signal lines in a winding manner so as to be along the gap, in other words, so as to evade the pixel electrodes.

On the other hand, according to the foregoing arrangement, (a) the layer having the scanning line and the signal lines and (b) the layer having the pixel electrodes are separately provided. Thus, it is possible to align all the signal lines in parallel regardless of the size and the position of the pixel electrodes. The scanning line is arranged as in the foregoing manner. Then, there is provided the connection section between the layers, so that electrical connection between the separate layers is realized.

Thus, it is possible to make such an arrangement that: while the scanning line and the signal lines are disposed in the same direction as conventional ones, that is, a vertical direction of a screen is the direction of the signal lines and a horizontal direction of the screen is the direction of the scanning line, it is possible to align the pixel electrodes in the unit pixel in a disposing direction of the signal lines without complicating a wiring layout of the scanning line and the signal lines.

As a result, in a case of manufacturing a multipanel type display device in which the active matrix substrates are combined with each other as display panels in a disposing direction of the scanning line (crosswise), color pixels in the unit pixel of each display panel are aligned in a disposing direction of the signal lines (vertical direction), so that it is possible to uniform the distance from the seam line between the display panels to the closest color pixel as to all the colors.

Therefore, in the case of manufacturing a multipanel type display device in which display panels having a conventional disposing direction of the scanning line and the signal lines are combined with each other in a crosswise direction, it is possible to remarkably restrain occurrence of an outstanding seam which occurs when a display panel is apparently colored like a rainbow in the vicinity of a seam between the display panels.

Further, besides the active matrix substrate of the foregoing arrangement, it is possible to obtain the same effect by using an active matrix substrate which is constituted of unit pixels each of which is provided on a crossing point between a scanning line and each of signal lines in a matrix manner via each of switching elements, and the unit pixel includes pixel electrodes which conduct in combination with the signal lines that correspond to the pixel electrodes when the switching element is ON by applying a scanning signal to the scanning line, and the active matrix substrate includes at least (a) a first layer having a connection electrode constituted of an extended portion of a pixel-electrode-side terminal of the switching element, and (b) a second layer having the pixel electrodes aligned along a disposing direction of the signal lines, wherein between the first layer and the second layer, there is provided an interlayer insulating film for insulating the first and second layers from each other, and in the interlayer insulating film, there is provided a connection section for electrically connecting each of the pixel electrodes of the second layer to the connection electrode of the first layer.

Further, it is possible to obtain the same effect by using an active matrix substrate which is constituted of unit pixels each of which is provided on a crossing point between a scanning line and each of signal lines in a matrix manner via each of switching elements, and the unit pixel includes pixel electrodes which conduct in combination with the signal lines that correspond to the pixel electrodes when the switching element is ON by applying a scanning signal to the scanning line, wherein in the unit pixel, there are provided the pixel electrodes along a disposing direction of the signal lines, and at least two of the signal lines are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges the signal lines.

Further, an active matrix substrate of the present invention includes a plurality of unit pixels disposed in a matrix manner, wherein each of the unit pixels includes at least: a scanning line disposed along a first direction (X direction); a plurality of signal lines disposed along a second direction (Y direction) which crosses the first direction; a plurality of switching elements, connected to the scanning line, which are provided so as to correspond to the respective signal lines; an interlayer insulating film that is provided on the scanning line, the signal lines, and the switching elements; a plurality of pixel electrodes that are made ON/OFF by the switching elements so as to or not to conduct to the signal lines; and a plurality of contact holes, provided in the interlayer insulating film so as to correspond to the respective pixel electrodes, which connect the switching elements to the pixel electrodes, wherein a distance between the contact holes and the scanning line is different for each of the contact holes in the unit pixel. In this case, it is possible to obtain the same effect as the foregoing arrangements.

It is possible to make such an arrangement that, for example, the pixel electrodes are aligned along the second direction (Y direction) and correspond to the respective signal lines.

Further, a display device of the present invention includes the active matrix substrates which are combined with each other as display panels in a disposing direction of a scanning line (crosswise), and the pixel electrodes in the unit pixel correspond to respective colors for color display.

Further, a display device of the present invention includes: one or more active matrix substrates; one or more counter substrates; and one or more display media provided between the active matrix substrates and the counter substrates, wherein in a case where the active matrix substrates are provided in plurality, the active matrix substrates are connected to each other in a disposing direction of the scanning line (crosswise), and in a case where the counter substrates are provided in plurality, the counter substrates are connected to each other in the disposing direction of the scanning line (crosswise), and the pixel electrodes in the unit pixel correspond to respective colors for color display, and the active matrix substrates and/or the counter substrates is provided in plurality.

According to the arrangement, it is possible to make such an arrangement that: while the scanning line and the signal lines are disposed in the same direction as conventional ones, that is, a vertical direction of a screen is the direction of the signal lines and a horizontal direction of the screen is the direction of the scanning line, it is possible to align the pixel electrodes in the unit pixel in a disposing direction of the signal lines without complicating a wiring layout of the scanning line and the signal lines.

Thus, color pixels in the unit pixel of each display panel are aligned in a disposing direction of the signal lines (vertical direction), so that it is possible to uniform the distance from the seam line between the display panels to the closest color pixel as to all the colors.

Therefore, it is possible to remarkably restrain occurrence of an outstanding seam which occurs when a display panel is apparently colored like a rainbow in the vicinity of a seam between the display panels.

Further, a display device of the present invention includes the active matrix substrates combined with each other as color detection panels in a disposing direction of a scanning line, and the pixel electrodes in the unit pixel of the active matrix substrate correspond to respective colors for color detection.

Therefore, light which functions as an input image can be converted into an analog electric signal according to the light intensity so as to be output to the outside of the active matrix substrate.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a plan view showing a schematic arrangement of one unit pixel in an example of how an active matrix substrate according to the present invention is arranged.

FIG. 2(a) is a cross sectional view taken along line A-A′ of the active matrix substrate, and FIG. 2(b) is a cross sectional view taken along line B-B′ of the active matrix substrate.

FIG. 3 is a plan view showing a schematic arrangement of one unit pixel in another example of how the active matrix substrate according to the present invention is arranged.

FIG. 4 is a plan view showing a schematic arrangement of one unit pixel in still another example of how the active matrix substrate according to the present invention is arranged.

FIG. 5 is a plan view showing a schematic arrangement of one unit pixel in still another example of how the active matrix substrate according to the present invention is arranged.

FIG. 6 is a plan view showing a schematic arrangement of one unit pixel in still another example of how the active matrix substrate according to the present invention is arranged.

FIG. 7 is a plan view showing a schematic arrangement of one unit pixel in still another example of how the active matrix substrate according to the present invention is arranged.

FIG. 8 is a plan view showing a schematic arrangement of one unit pixel in still another example of how the active matrix substrate according to the present invention is arranged.

FIG. 9 is a cross sectional view taken along line C-C′ of the active matrix substrate.

FIG. 10 is a plan view showing a schematic arrangement of one unit pixel in still another example of how the active matrix substrate according to the present invention is arranged.

FIG. 11 is a plan view showing a schematic arrangement of one unit pixel in still another example of how the active matrix substrate according to the present invention is arranged.

FIG. 12 is a cross sectional view taken along line D-D′ of the active matrix substrate.

FIG. 13 is a plan view showing a schematic arrangement of a whole interior portion of a multipanel type liquid crystal display device according to the present invention as an example of how the device is arranged.

FIG. 14(a) to FIG. 14(c) are cross sectional views schematically showing a whole arrangement in respective examples of how the multipanel type display device is arranged, and FIG. 14(a) is a cross sectional view showing an example of how display panels are connected to each other in the multipanel type display device, and FIG. 14(b) is a cross sectional view showing another example of how display panels are connected to each other in the multipanel type display device, and FIG. 14(c) is a cross sectional view showing still another example of how display panels are connected to each other in the multipanel type display device.

FIG. 15 is a plan view showing a schematic arrangement of a vicinity of a seam line in an example of how the multipanel type display device according to the present invention is arranged.

FIG. 16 is a plan view showing a schematic arrangement of a vicinity of a seam line in another example of how the multipanel type display device according to the present invention is arranged.

FIG. 17 is a plan view showing a schematic arrangement of a vicinity of a seam line in still another example of how the multipanel type display device according to the present invention is arranged.

FIG. 18 is a plan view showing a schematic arrangement of a vicinity of a seam line in still another example of how the multipanel type display device according to the present invention is arranged.

FIG. 19(a) and FIG. 19(b) are plan views showing an example of how a conventional liquid crystal display device is arranged, and FIG. 19(a) is a plan view showing an arrangement in which liquid crystal panels have not been combined with each other, and FIG. 19(b) is a plan view showing an arrangement in which liquid crystal panels have been combined with each other.

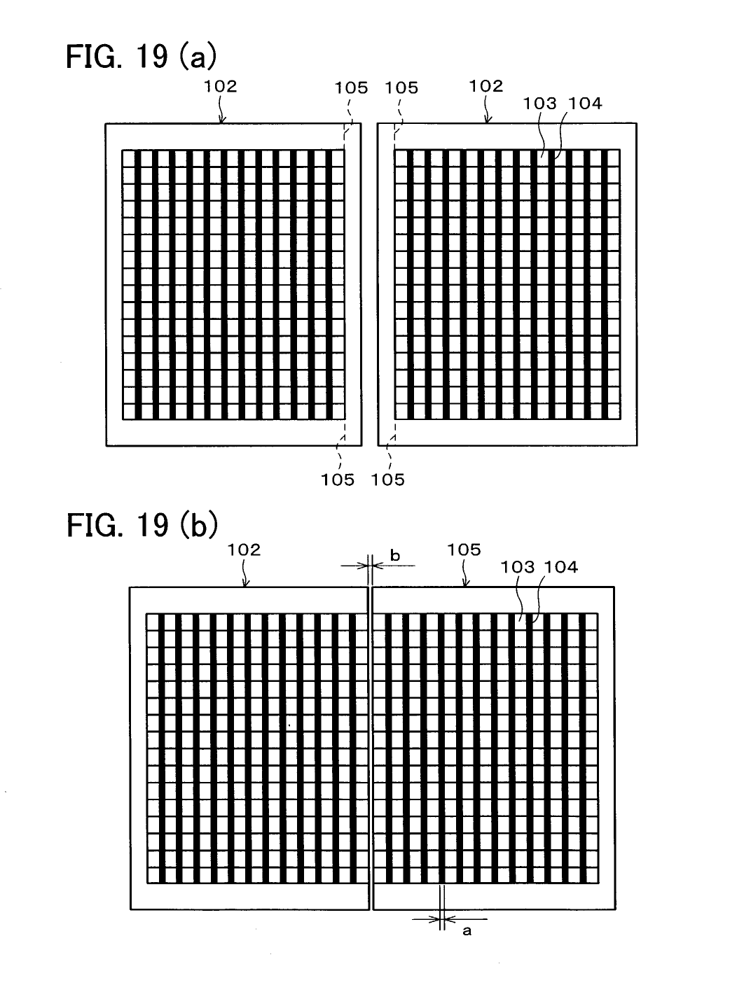

FIG. 20(a) to FIG. 20(c) show examples of how a display device having a general multipanel structure is arranged, and FIG. 20(a) shows an example of how liquid crystal panels are combined with each other, and FIG. 20(b) shows another example of how the liquid crystal panels are combined with each other, and FIG. 20(c) shows still another example of how the liquid crystal panels are combined with each other.

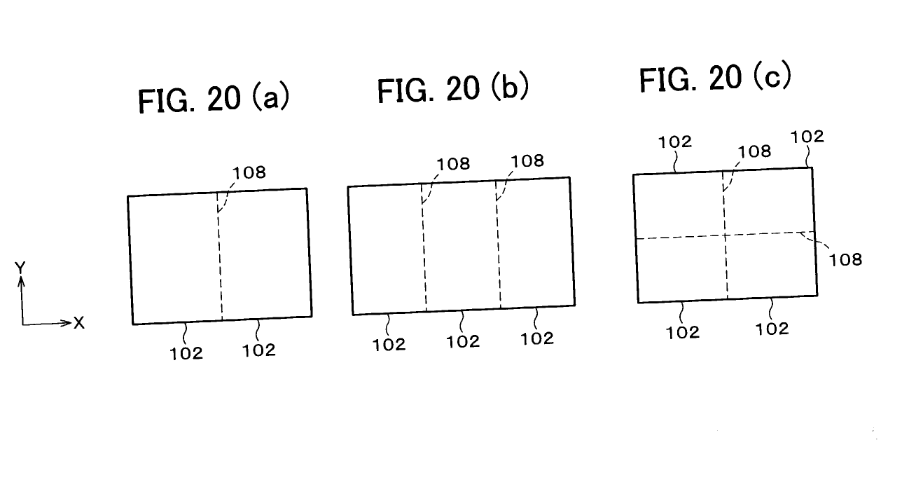

FIG. 21 is an oblique perspective and enlarged view showing a seam of a conventional multipanel type display device.

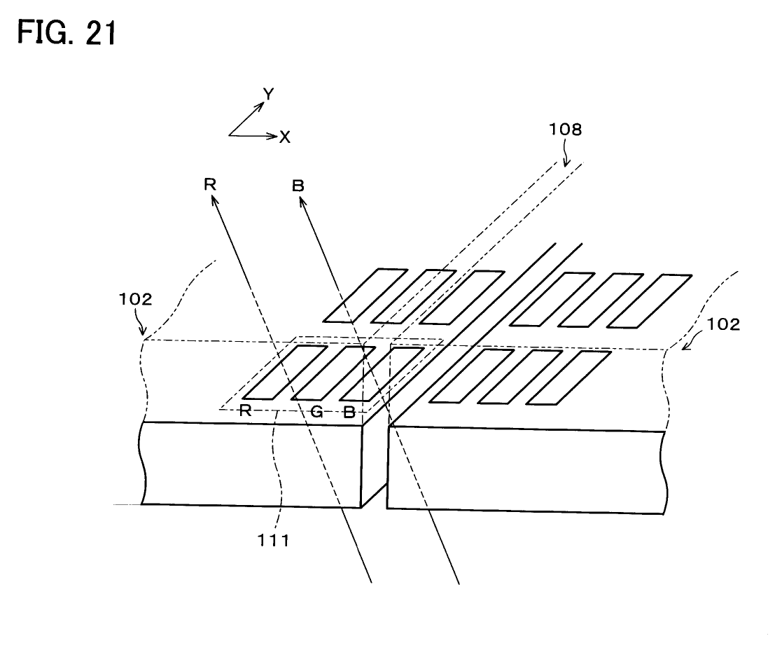

FIG. 22(a) and FIG. 22(b) show directions in which color pixels are aligned, and FIG. 22(a) shows a direction in which color pixels are aligned, and FIG. 22(b) shows another direction in which color pixels are aligned.

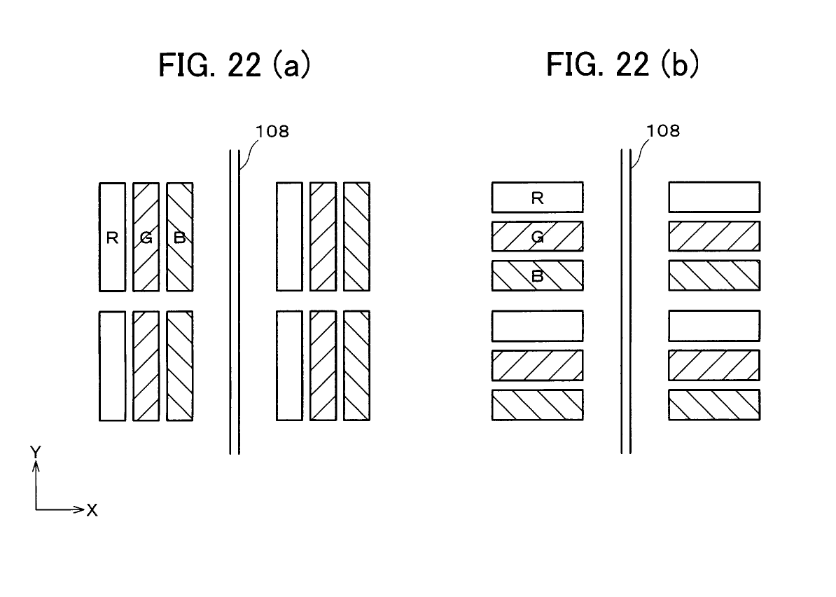

FIG. 23 is an oblique perspective and enlarged view showing a seam of a conventional multipanel type display device.

FIG. 24 is a plan view showing a schematic arrangement of one unit pixel in an example of how a conventional active matrix substrate is arranged.

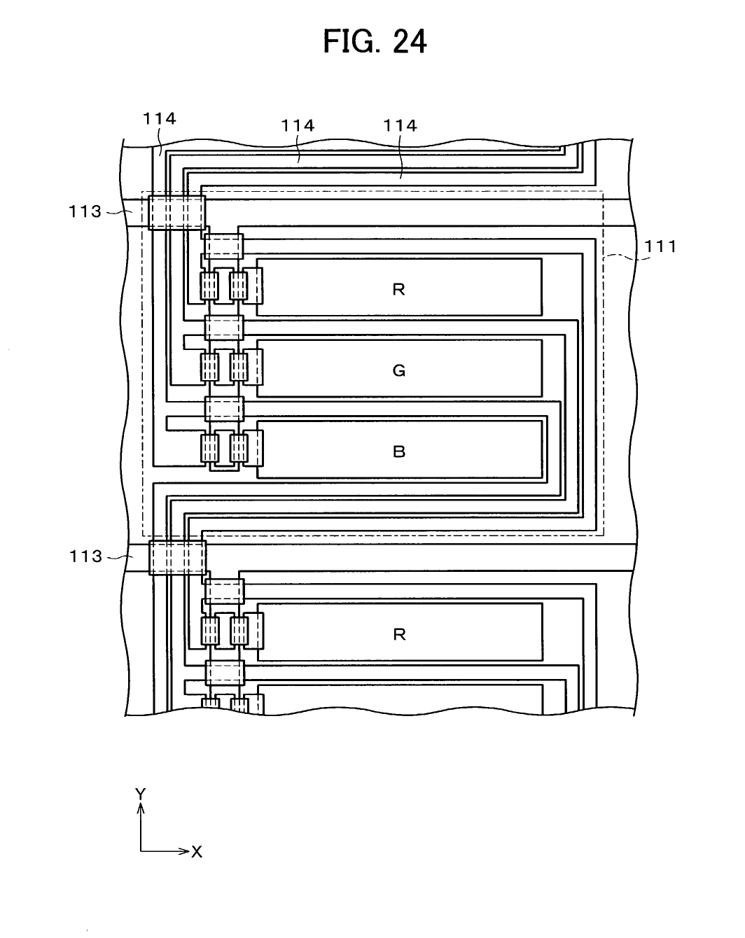

FIG. 25 is a plan view showing a schematic arrangement of one unit pixel in an example of how a conventional active matrix substrate is arranged.

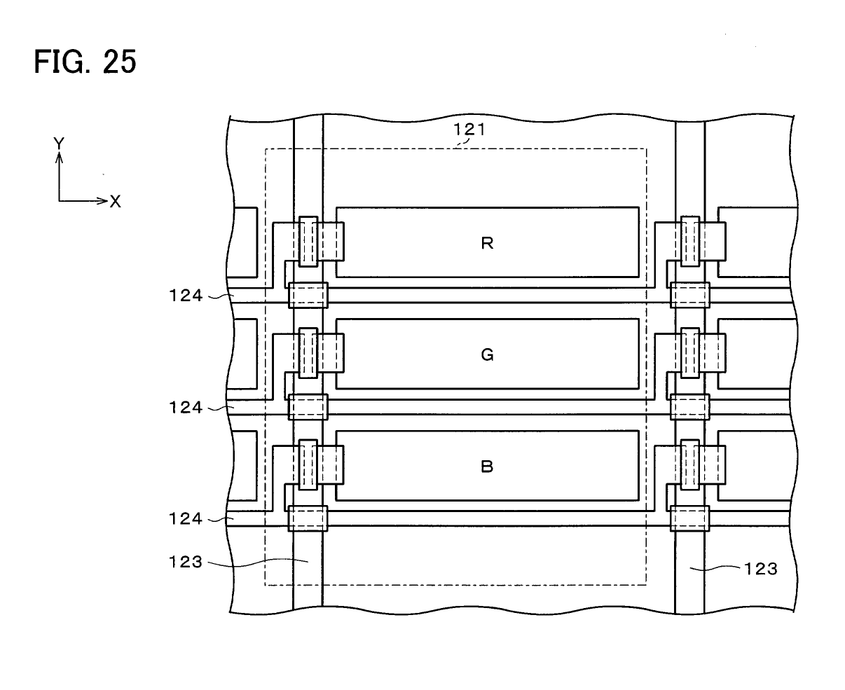

FIG. 26 is a plan view showing a schematic arrangement of one unit pixel in an example of how a conventional active matrix substrate is arranged.

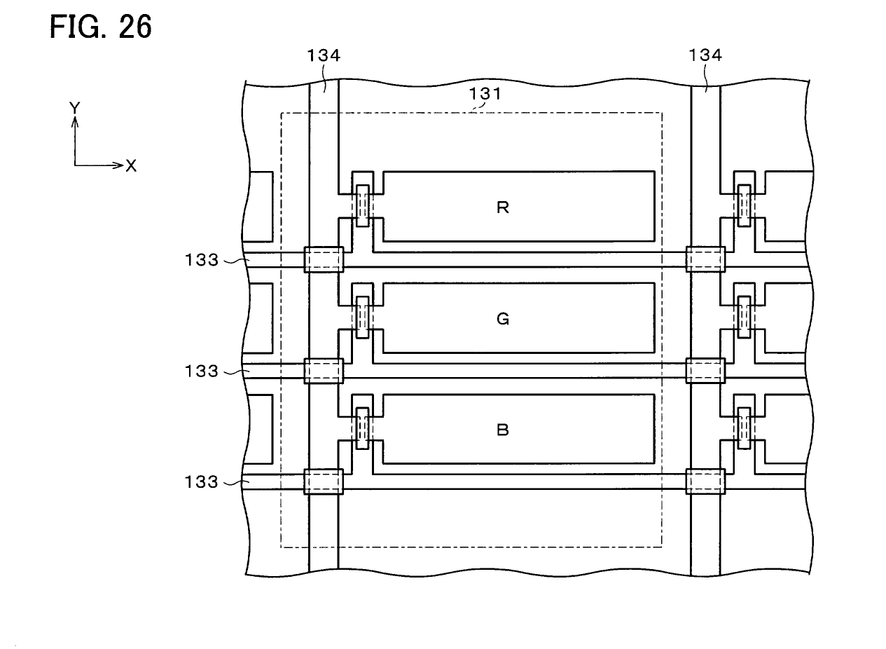

FIG. 27 is a plan view showing a schematic arrangement in an example of how a conventional active matrix substrate is arranged.

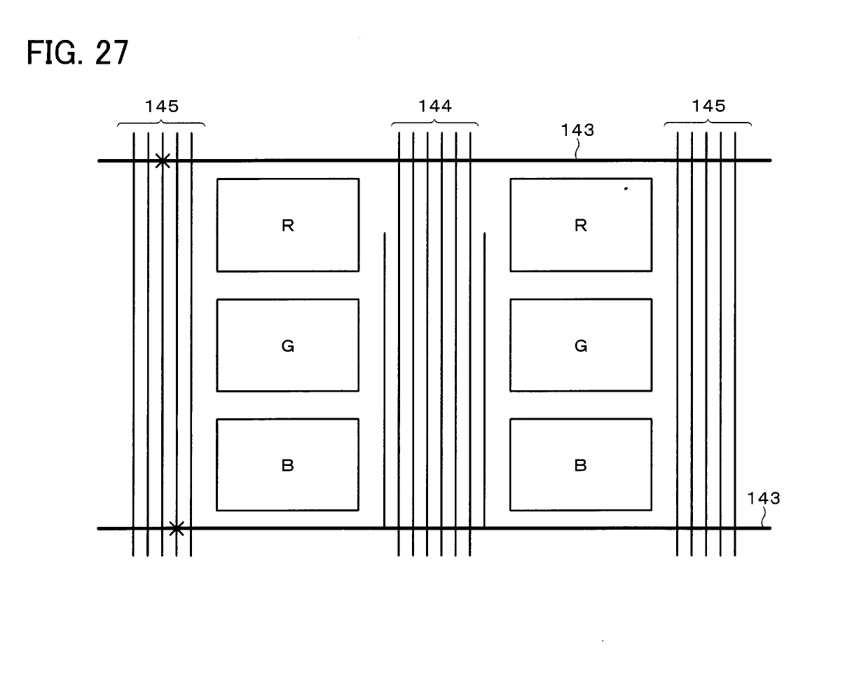

FIG. 28 is a schematic block diagram in a case where the active matrix substrate of the present invention is used in a detector for detecting image data.

### DESCRIPTION OF THE EMBODIMENTS

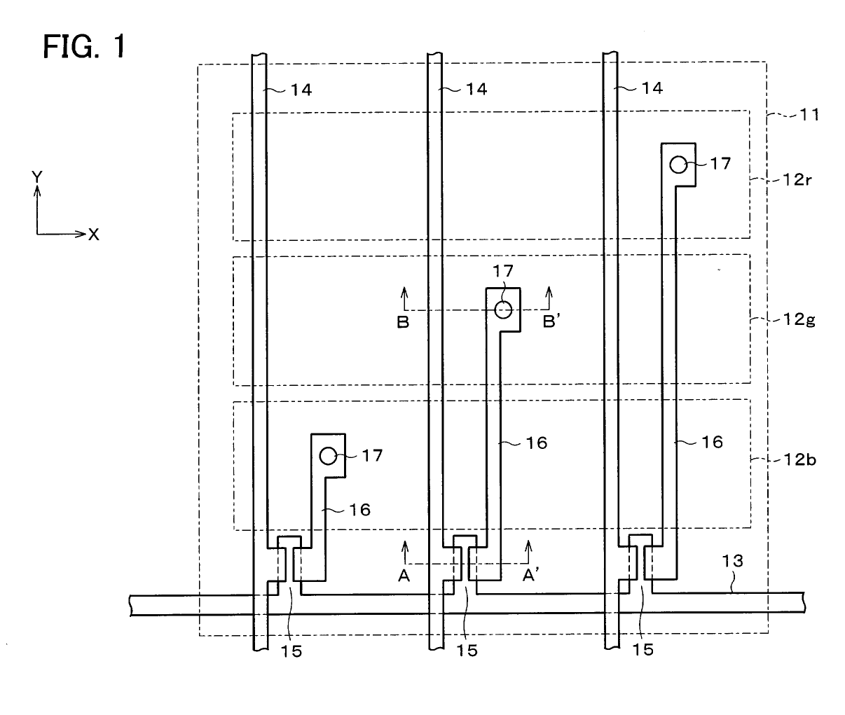

One embodiment of the present invention will be described based on FIG. 1 to FIG. 18 as follows.

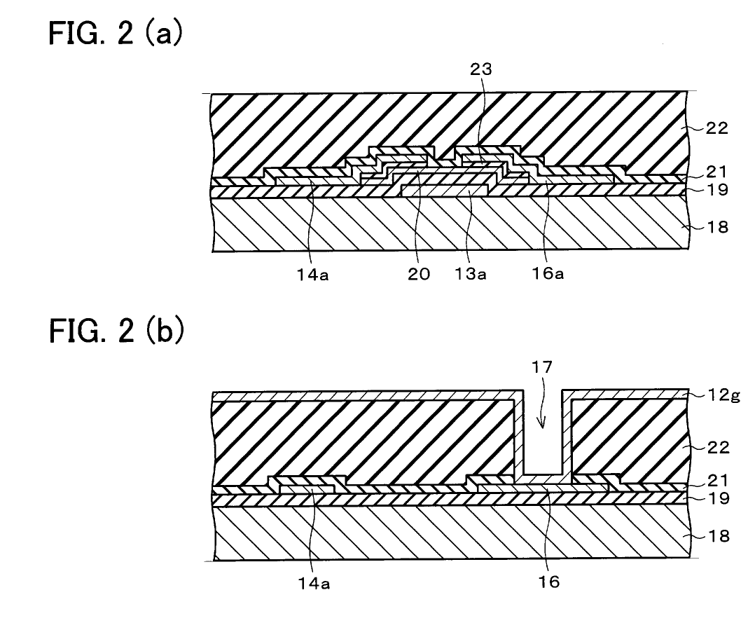

FIG. 1 is a plan view showing one unit pixel of an active matrix substrate according to the present embodiment. Further, FIG. 2(a) is a cross sectional view taken along line A-A′ of FIG. 1 and FIG. 2(b) is a cross sectional view taken along line B-B′ of FIG. 1.

On a base substrate 18 made of such materials as glass, plastic, and the like, a scanning line (gate line) 13 made of metallic film is provided straight in a direction in which the scanning line 13 extends in a crosswise direction (horizontal direction, X direction) in FIG. 1. Further, parts of the scanning line 13 (three parts in FIG. 1) are branched at three points at which the scanning line 13 is equally divided into substantially three portions in X direction of the unit pixel 11, and the branching points correspond to gate electrodes (scanning-line-side terminals) 13a of a TFT (thin film transistor)(switching element) 15 described later. The unit pixel 11 is substantially square.

The scanning line 13 is constituted of metallic thin film such as Ta, Al, Ti, Mo, Cr, and W, or is constituted of alloyed film or film stack of them, and is patterned into a predetermined shape. On the scanning line 13, a gate insulating film 19 is formed so as to cover substantially entire surfaces of the scanning line 13 and the base substrate 18 (see FIG. 2). The gate insulating film 19 is constituted of SiNx, SiO2, and anodic oxide film of the scanning line 13.

A channel layer 20 of a-Si, poly-Si, CdSe, organic semiconductor, and the like is provided on the gate insulating film 19 in accordance with pattern formation so that the channel layer 20 is positioned above a gate electrode 13a brunched from the scanning line 13. On the gate insulating film 19, plural signal lines 14, a source electrode (signal-line-side terminal) 14a, plural connection electrodes 16, and a drain electrode (pixel-electrode-side terminal) 16a are provided. The signal lines 14 and the connection electrode 16 are constituted of metallic thin film such as Ta, Al, Ti, Mo, Cr, and W, and conductive oxide film such as ITO (indium tin oxide), or alloyed film or film stack of them, and are patterned into a predetermined shape. In this manner, there are provided thin film transistors (TFT15) each of which includes three electrodes: a gate, a source, and a drain. The plural signal lines 14 are provided straight along Y direction which crosses a direction in which the scanning line 13 is provided (X direction). Then, all the TFTs15 are unevenly distributed near the scanning line (lower side of the figure) in the unit pixel.

Note that, an n+ type contact layer 23 such as a-Si, Poly-Si is suitably provided on a joint interface between the semiconductor channel layer 20 and the source electrode 14a drain electrode 16a.

In addition, an insulating protection film 21 constituted of SiNx thin film is provided so as to cover substantially entire surfaces of the scanning line 13, the signal lines 14, and the TFTs 15. Further, there are provided an interlayer insulating film 22 constituted of acrylate resin, polyimide resin, and the like, on the insulating protection film 21. Further, plural pixel electrodes are provided on the interlayer insulating film 22. That is, the plural pixel electrodes include: a red (R) pixel electrode 12r; a green (G) pixel electrode 12g; and a blue (B) pixel electrode 12b, and all the pixel electrodes (red, blue, green) are referred to as pixel electrodes 12. All the pixel electrodes in one unit pixel 11 correspond to a single scanning line 13.

The interlayer insulating film 22 serves as a planarizing film which planarizes a surface of the active matrix substrate. When the foregoing structure is used, the plural pixel electrodes 12 can be freely arranged in a direction different from a conventional structure. Thus, in this arrangement, the plural pixel electrodes 12 are aligned in a direction along the signal lines 14. As the pixel electrodes 12, ITO is used in a transmissive display device, and Al or Ag are used in a reflective display device. Note that, it is also possible to use a material both as the interlayer insulating film 22 and as the insulating protection film 21.

Note that, the active matrix substrate in this arrangement example is arranged so that: contact holes (connection sections) 17 are formed in the insulating protection film 21 and the interlayer insulating film 22 so as to electrically connect the respective pixel electrodes 12 to the drain electrodes 16a, so that the pixel electrodes 12 are connected to the connection electrodes 16 through the contact holes 17. In this case, a distance between the plural contact holes 17 and the scanning line 13 is different for each of the contact holes 17. Corresponding to this, the drain electrodes 16a of the respective TFTs 15 are provided so that the drain electrodes 16a extend to the respective contact holes 17 as connection electrodes 16.

In the unit pixel 11, at least one of the signal lines 14 is superposed with the pixel electrodes 12 via the interlayer insulating film 22 in a flat manner.

According to the active matrix substrate of the present embodiment described above, the direction in which the scanning line is provided (X direction) and the direction in which the signal lines are aligned (Y direction) are arranged in the same manner as in conventional ones, and it is possible to provide the plural pixel electrodes in the unit pixel so that the pixel electrodes are aligned along the direction in which the signal lines are aligned. Further, the manufacturing process of the active matrix substrate (hereinbelow referred to merely as process) is generally found in Japanese Patent Official Gazette No. 2933879 (registration date: May 28, 1999) etc. Therefore, an additional process is not required in employing the foregoing wiring layout, so that it is possible to readily realize the active matrix substrate of the present invention.

Note that, upon using the active matrix substrate in a display etc., an electrode opposite to the pixel electrode may be additionally provided on a substrate on the side of the pixel electrode, or the electrode opposite to the pixel electrode may be provided on another substrate instead of the substrate on the side of the pixel electrode. The former can be used in a liquid crystal display using a so-called IPS (In Plane Switching) mode.

In a case where the active matrix substrate is used in a liquid crystal display device or an image detector, it is sometimes required to add auxiliary capacitance to each pixel electrode so that the respective pixel electrodes can accumulate charges.

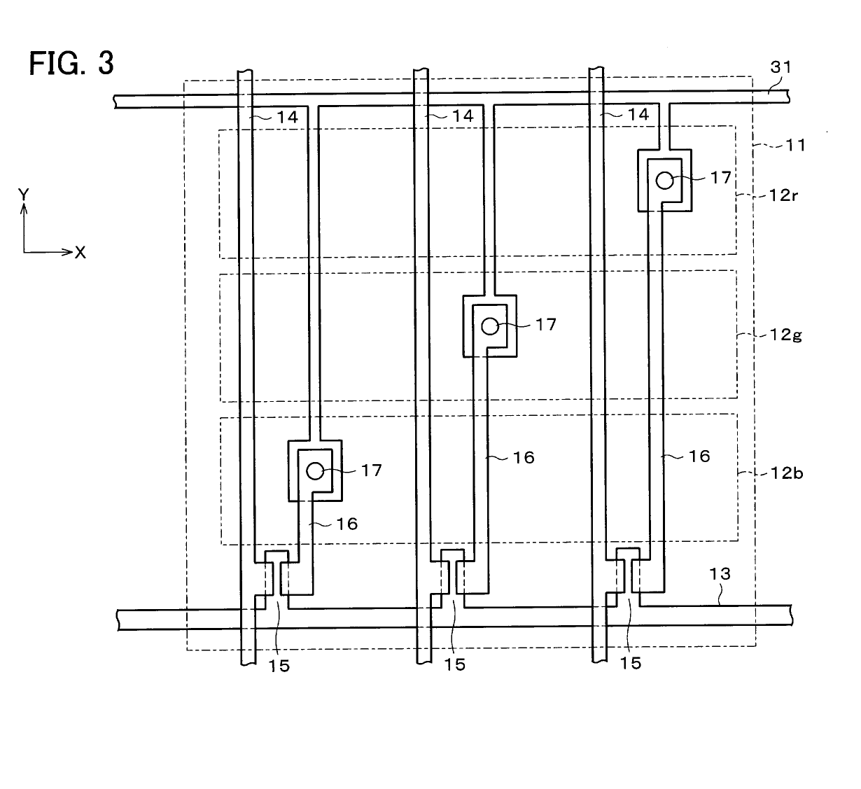

FIG. 3 is a plan view showing one unit pixel of the active matrix substrate, shown in FIG. 1, in which the auxiliary capacitance has been added. Here, a single auxiliary capacitance line 31 is provided in X direction on each unit pixel. It is preferable to form the auxiliary capacitance line 31 in the same process upon forming the above-mentioned scanning line 13. Parts of the auxiliary capacitance line 31 (three parts in FIG. 3) are branched at three points at which the auxiliary capacitance line 31 is equally divided into substantially three portions in X direction of the unit pixel 11, and portions extended from the branching points are superposed with parts of the above-mentioned connection electrode 16 (extended portion of the drain electrode 16a). In a superposing area of both the members (extended portion of the auxiliary capacitance line 31 and the connection electrode 16), a gate insulating film 19 exists between both the members, so that the gate insulating film 19 acts as a dielectric material and as an auxiliary capacitor.

Note that, a method of adding the auxiliary capacitance line is not limited to the foregoing manner, but the following methods may be employed: for example, one of the scanning lines adjacent to each other serves as the auxiliary capacitance line, for example, as to FIG. 3, a scanning line in an upper unit pixel serves as an auxiliary capacitance line in a lower unit pixel. Further, the method of adding the auxiliary capacitance line may be arranged as follows: plural auxiliary capacitance lines (three lines in FIG. 3) in each unit pixel are separately provided in X direction so as to correspond to the respective pixel electrodes.

In this manner, it is possible to readily add the auxiliary capacitance as required, without adding a new process.

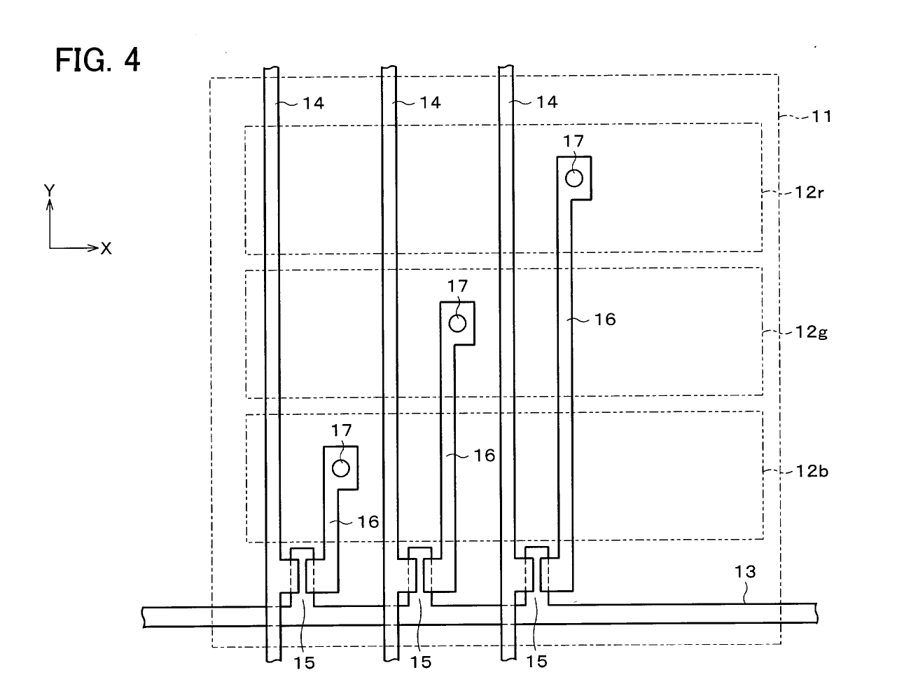

FIG. 4 shows a modification example of the active matrix substrate shown in FIG. 1. Here, plural signal lines 14 provided in Y direction in each unit pixel are unevenly distributed on one side (left side in FIG. 4) in the unit pixel 11. Thus, in each unit pixel 11, the respective pixel electrodes 12 are divided into two areas: an area, from one end of the scanning line (left side in FIG. 4) to a center of the unit pixel 11, where the signal lines are superposed with the pixel electrodes 12; and an area, from the other end of the scanning line (right side in FIG. 4) to the center, where the signal lines are not superposed with the pixel electrodes 12. Of course, it is also possible to add the above-mentioned auxiliary capacitance line 31. The present arrangement is effective in preventing disconnection of the signal lines 14 which occurs in the vicinity of the seam when a multipanel type display device is realized. Concrete effects will be detailed later.

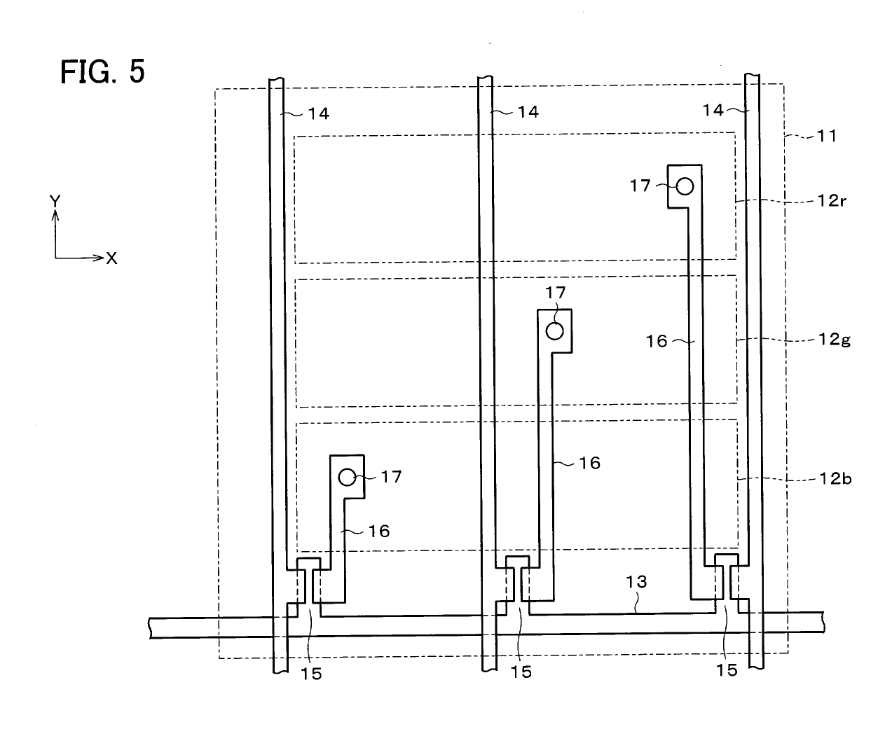

FIG. 5 shows still another modification example of the active matrix substrate shown in FIG. 1. Here, out of the plural signal lines 14 provided in Y direction in each unit pixel, two signal lines 14 (right and left) are disposed on both right and left ends of the unit pixel 11 so that the two signal lines 14 are not superposed with the pixel electrode 12. When this layout is used, each of the two right and left signal lines can be disposed on a non-display area (generally, it is referred to as a black matrix, a light shielding area in a matrix manner which performs color separation from an adjacent pixel) formed in a gap between the unit pixels adjacent to each other, so that it is possible to effectively use the non-display area and to improve a pixel aperture ratio. Of course, it is also possible to add the above-mentioned auxiliary capacitance line 31. Further, as to the signals lines 14 in each unit pixel, either of the two signal lines 14 (that is, signal lines disposed on both ends of the unit pixel) may be disposed so as not to be superposed with the pixel electrode 12.

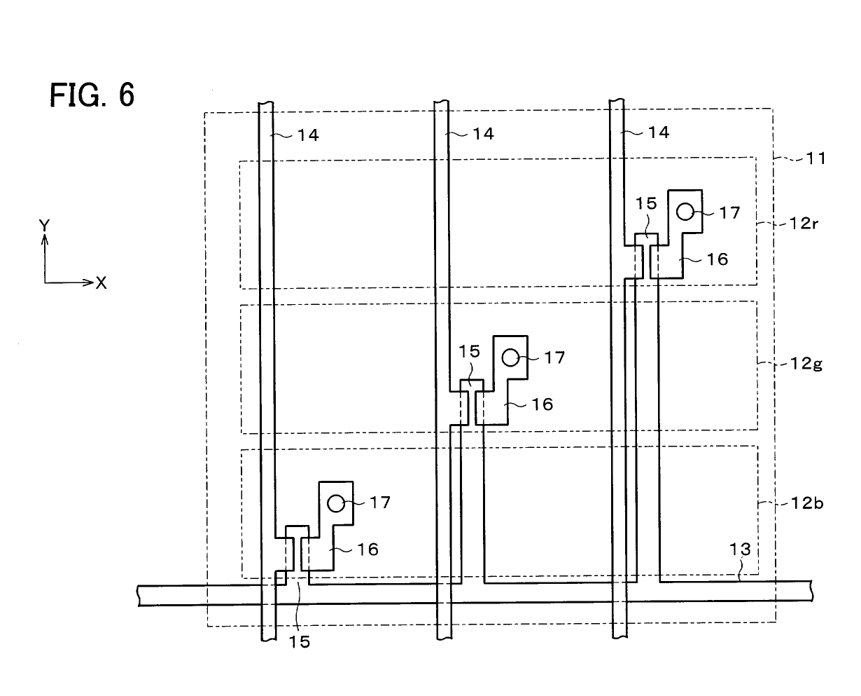

FIG. 6 shows still another modification example of the active matrix substrate shown in FIG. 1. Here, the TFTs 15 corresponding to the plural pixel electrodes 12 are provided in the vicinity of the respective pixel electrodes 12r • 12g • 12b. Thus, it is possible to arrange the respective pixel electrodes 12 so as to be superposed with upper portions of the TFTs 15, so that it is possible to electrically shield the TFTs 15. Further, in a case where this arrangement is applied to a reflective display device, a metallic film such as Al and Ag is used to form the pixel electrode 12, so that it is possible to optically shield the TFTs 15. Of course, it is also possible to add the above-mentioned auxiliary capacitance line 31.

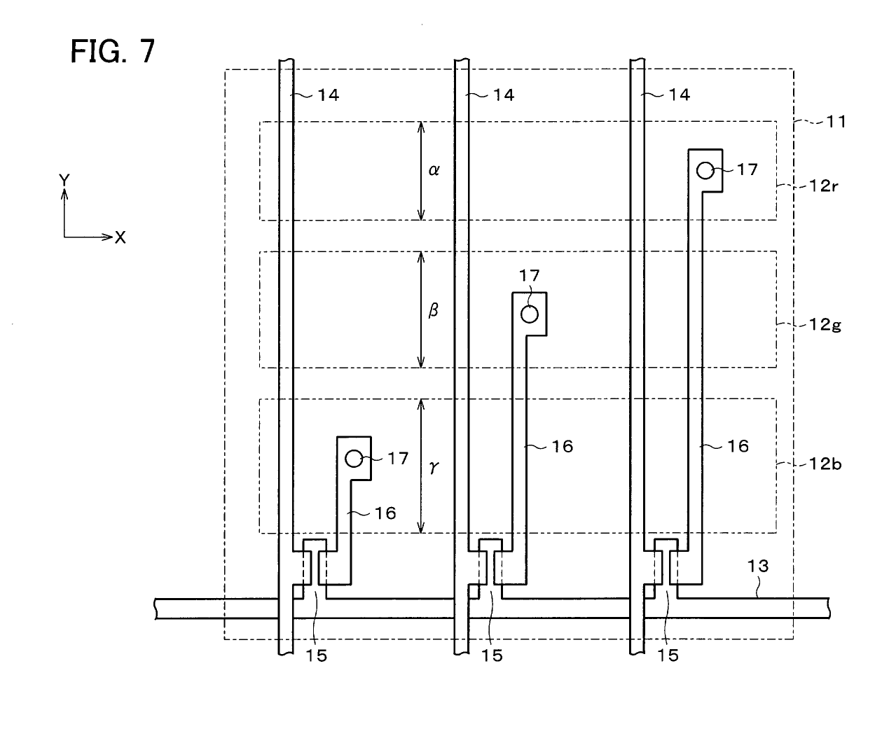

FIG. 7 shows still another modification example of the active matrix substrate shown in FIG. 1. Here, the pixel electrodes 12r • 12g • 12b are different from each other in terms of width in X direction (length in Y direction). Concretely, the narrower widths in X direction of the respective pixel electrodes 12 become, the further the pixel electrodes are positioned from the gate electrode 13a. That is, a relationship of the widths of the pixel electrodes is α<β<γ. As to the active matrix substrate shown in FIG. 1, since the pixel electrodes 12 are different from each other in terms of a total area in which the connection electrodes 16 are not superposed, aperture ratios of the respective pixel electrodes are different from each other in a case where the connection electrode 16 is made of non-translucent film like a metallic film. However, when the active matrix substrate of the present arrangement is employed, the total area with which the connection electrodes 16 are not superposed can be made to be substantially the same as total areas of other pixel electrodes 12, so that it is possible to equalize all the aperture ratios of the plural pixel electrodes 12. Of course, it is also possible to add the auxiliary capacitance line 31.

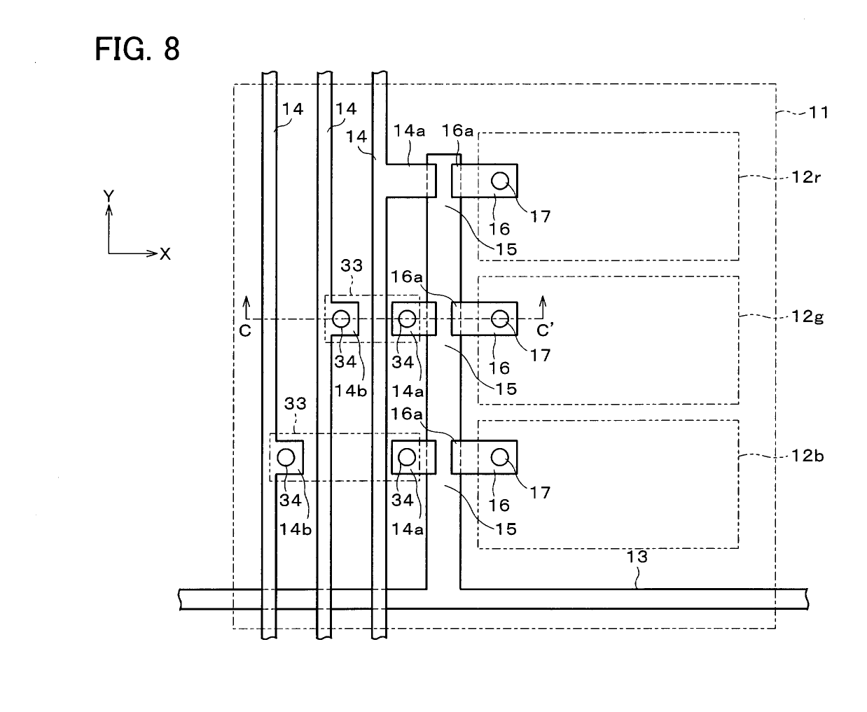

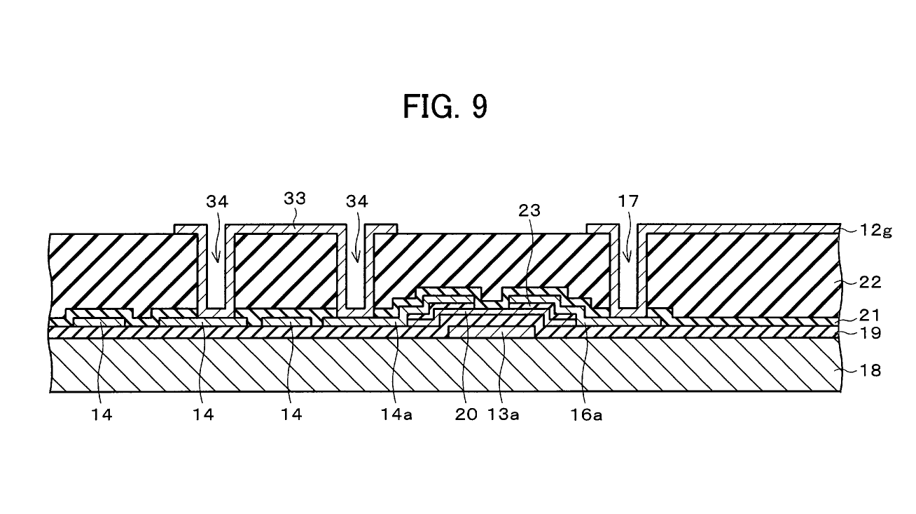

FIG. 8 is a plan view showing one unit pixel in still another example of how the active matrix substrate of the present invention is arranged. Further, FIG. 9 is a cross sectional view taken along line C-C′ of FIG. 8.

On a base substrate 18 made of glass or plastic, a scanning line 13 made of metallic film is provided so that the scanning line 13 extends from side to side (horizontal direction, X direction) as shown in FIG. 8. Further, a part of the scanning line 13 is branched, and the branched part corresponds to a gate electrode 13a of a TFT (thin film transistor) 15 described later.

The scanning line 13 is constituted of metallic thin film such as Ta, Al, Ti, Mo, Cr, and W, or is constituted of alloyed film or film stack of them, and is patterned into a predetermined shape. On the scanning line 13, a gate insulating film 19 is formed so as to cover substantially entire surfaces of the scanning line 13 and the base substrate 18 (see FIG. 9). The gate insulating film 19 is constituted of SiNx, SiO2, and anodic oxide film of the scanning line 13.

A channel layer of a-Si, poly-Si, CdSe, organic semiconductor, and the like is provided on the gate insulating film 19 in accordance with pattern formation so that the channel layer is positioned above a gate electrode 13a brunched from the scanning line 13. On the gate insulating film 19, plural signal lines 14, a source electrode 14a, plural connection electrodes 16, and a drain electrode 16a are provided. The signal lines 14 and the connection electrode 16 are constituted of metallic thin film such as Ta, Al, Ti, Mo, Cr, and W, and conductive oxide film such as ITO, or alloyed film or film stack of them, and are patterned into a predetermined shape. In this manner, there are provided TFTs (thin film transistors) 15 each of which includes three electrodes: a gate, a source, and a drain. The plural signal lines 14 are provided straight along Y direction which crosses a direction in which the scanning line 13 is provided (X direction). Then, all the TFTs15 are aligned on the single gate electrode 13a branched from the scanning line 13.

Note that, an n-type contact layer 23 such as a-Si, Poly-Si is suitably provided on a joint interface between the semiconductor channel layer 20 and the source electrode 14a drain electrode 16a.

In addition, an insulating protection film 21 constituted of SiNx thin film is provided so as to cover substantially entire surfaces of the scanning line 13, the signal lines 14, and the TFTs 15. Further, there are provided an interlayer insulating film 22 constituted of acrylate resin, polyimide resin, and the like, on the insulating protection film 21. Further, plural pixel electrodes are provided on the interlayer insulating film 22. That is, the plural pixel electrodes include: a red (R) pixel electrode 12r; a green (G) pixel electrode 12g; and a blue (B) pixel electrode 12b, and all the pixel electrodes (red, blue, green) are referred to as pixel electrodes 12. All the pixel electrodes in one unit pixel 11 correspond to a single scanning line 13.

The interlayer insulating film 22 serves as a planarizing film which planarizes a surface of the active matrix substrate. When the foregoing structure is used, the plural pixel electrodes 12 can be freely disposed in a direction different from a conventional structure. Thus, in this arrangement, the plural pixel electrodes 12 are aligned in a direction along the signal lines 14. As the pixel electrodes 12, ITO is used in a transmissive display device, and Al or Ag are used in a reflective display device.

Note that, the active matrix substrate in this arrangement example is arranged so as to electrically connect the respective pixel electrodes 12 to the drain electrodes 16a so that: contact holes (connection sections) 17 are formed in the insulating protection film 21 and the interlayer insulating film 22 so as to electrically connect the respective pixel electrodes 12 to the connection electrodes 16 (drain electrodes 16a). Signal lines 14 and the corresponding source electrodes of the TFTs 15 are electrically connected to each other by bypass electrodes 33 formed on the interlayer insulating film 22. The bypass electrodes 33 can be formed in the same process as in the pixel electrodes 12 at the same time, so that it is not required to add a new process. When the foregoing structure using the bypass electrodes 33 is used in this manner, the following advantage can be obtained; even though plural signal lines are provided in parallel, each signal line can be connected to the TFT corresponding to the signal line while retaining the insulation between the signal lines without adding a new process. Further, a material whose non-permittivity is relatively small, such as an acrylate resin is used to form a film having 2 to 3 μm thickness, and the formed film is used as the interlayer insulating film 22. This can restrict parasitic capacitance, which occurs between the bypass electrode 33 and the signal line 14 under the interlayer insulating film 22 under the bypass electrode 33. By employing the present structure in this manner, it is possible to restrict electrical influence given to the signal line to minimum, so that this structure is very useful. Note that, it is also possible to form the bypass electrode on a layer lower than the signal line 14 by using the same material and process as in the scanning line 13. However, in this case, there exists the gate electrode 19 having 0.3 to 0.5 μm thickness between the bypass electrode and the signal line 14, so that the parasitic capacitance increases. Thus, in a case where a wide-area or highly-fine active matrix substrate is manufactured, it is preferable to form the bypass electrode 33 by using the same material and process as in the pixel electrode 12.

In this example, a distance between the plural contact holes and the scanning line is different for each of the contact holes.

According to the active matrix substrate described above, the direction in which the scanning line is provided (X direction) and the direction in which the signal lines are aligned (Y direction) are arranged in the same manner as in conventional ones, and it is possible to provide the plural pixel electrodes in the unit pixel so that the pixel electrodes are aligned along the direction in which the signal lines are aligned. Further, the manufacturing process of the active matrix substrate is generally found in Japanese Patent Official Gazette No. 2933879 etc. Therefore, an additional process is not required in employing the foregoing wiring layout, so that it is possible to readily realize the active matrix substrate of the present invention.

That is, for example, on and above the base substrate 18, the gate electrode 13a, the gate insulating film 19, the semiconductor channel layer 20, the source electrode 14a, and a contact layer 23 are provided in this order. So far, the process can be performed as in the manufacturing method of the conventional active matrix substrate. Next, the insulating protection film 21 and the interlayer insulating film 22 are formed, and the formed members are patterned into desired patterns. Thus, there are provided the contact holes 17 which pass through the insulating protection film 21 and the interlayer insulating film 22. Thereafter, above-mentioned ITO, Al, and Ag which are to constitute the pixel electrodes 12 are formed in accordance with sputtering, and they are patterned. Thus, the pixel electrodes 12 are electrically connected to the drain electrodes 16a of the TFTs 15 via the contact holes 17. In this manner, it is possible to manufacture the active matrix substrate of the present arrangement.

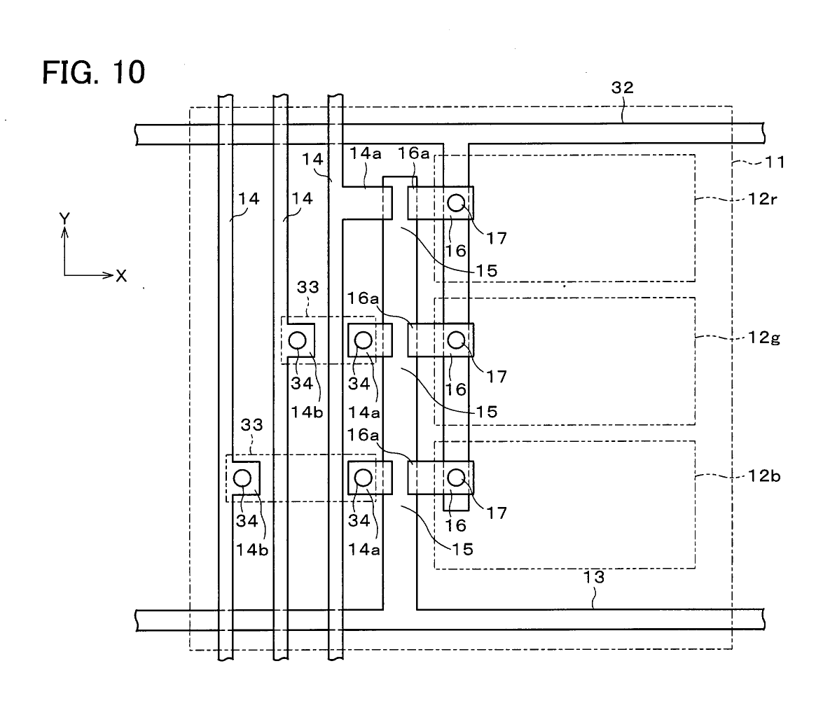

In a case where the active matrix substrate of FIG. 8 is used in a liquid crystal display device or an image detector, it is sometimes required to add auxiliary capacitance to each pixel electrode so that the respective pixel electrodes can accumulate charges. FIG. 10 is a plan view showing one unit pixel of the active matrix substrate, shown in FIG. 1, in which the auxiliary capacitance has been added. Here, a single auxiliary capacitance line 32 is provided in X direction on each unit pixel. It is preferable to form the auxiliary capacitance line 32 in the same process as in the scanning line 13 upon forming the above-mentioned scanning line 13. A part of the auxiliary capacitance line 32 is branched, and parts of the branched portion are superposed with parts of the above-mentioned drain electrode 16a (connection electrode 16). In a superposing area of both the members (extended portion of the auxiliary capacitance line 32 and the connection electrode 16), the gate insulating film 19 exists between both the members, so that the gate insulating film 19 acts as a dielectric material and as an auxiliary capacitor.

Note that, a method of adding the auxiliary capacitance line is not limited to the foregoing manner, but the following methods may be employed: for example, one of the scanning lines 13 adjacent to each other in Y direction serves as the auxiliary capacitance line, for example, as to FIG. 10, a scanning line in an upper unit pixel serves as an auxiliary capacitance line in a lower unit pixel. Further, the method of adding the auxiliary capacitance line may be arranged as follows: plural auxiliary capacitance lines (three lines in FIG. 10) in each unit pixel are separately provided in X direction so as to correspond to the respective pixel electrodes.

In this manner, it is possible to readily add the auxiliary capacitance as required, without adding a new process.

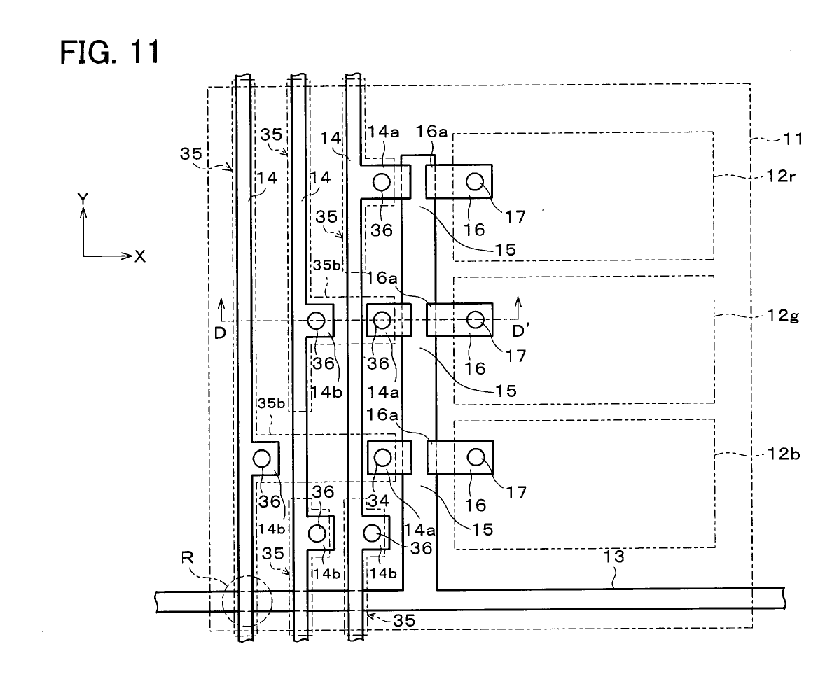

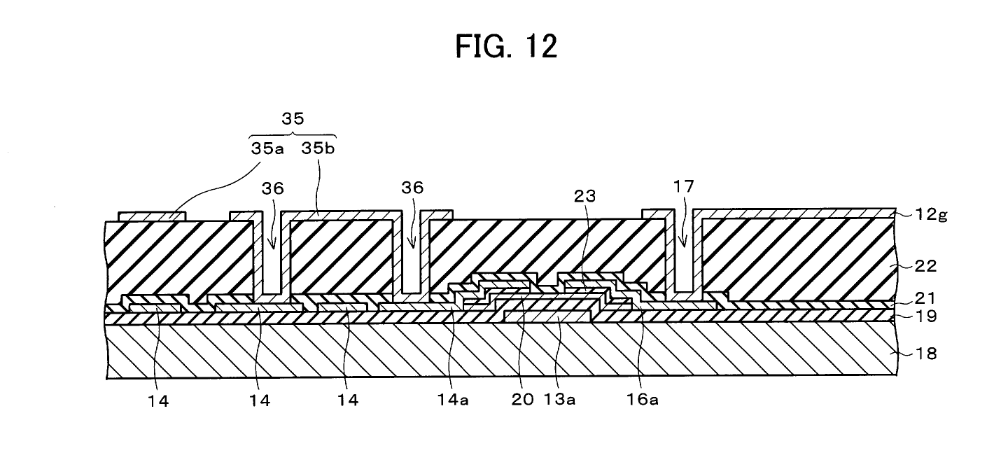

FIG. 11 shows a modification example of the active matrix substrate shown in FIG. 8. FIG. 12 is a cross sectional view taken along line D-D′. Here, a redundant electrode 35a is added on the interlayer insulating film 22. The redundant electrode 35a is formed by using the same material and process as in the pixel electrode 12 and the above-mentioned bypass electrode 33. That is, in a redundant wiring 35, a portion which is positioned above the signal line 14 is the redundant electrode 35a, and a portion which connects the signal line 14 to the source electrode 14a is a bypass electrode 35b.

Generally, in an active matrix substrate in which the scanning line 13 and the signal lines 14 are disposed in a matrix manner, connection failure of the signal line 14 tends to occur at a point where the scanning line 13 and the signal line 14 cross (for example, R point in FIG. 11). Then, in the active matrix substrate according to the present arrangement example, there is provided the redundant wiring 35 which bridges the crossing point of the scanning line 13 and the signal line 14. A contact hole 36 electrically connects the redundant wiring 35 to the signal line 14 at each portion where the redundant wiring 35 bridges the scanning line. Thus, even though the signal line is disconnected at the crossing point, it is possible to avoid the connection failure due to the redundant electrode 35a. Note that, it is possible to form the contact hole 36 in the same manner as in the contact hole 17 described above.

In a case where there is provided the auxiliary capacitance line (for example, in the active matrix substrate of FIG. 10), the idea of the redundant wiring is effective not only for the crossing point of the scanning line 13 and the signal line 14, but also for a crossing point of the auxiliary capacitance line and the signal line. In this case, the redundant wiring is formed so as to bridge the auxiliary capacitance line.

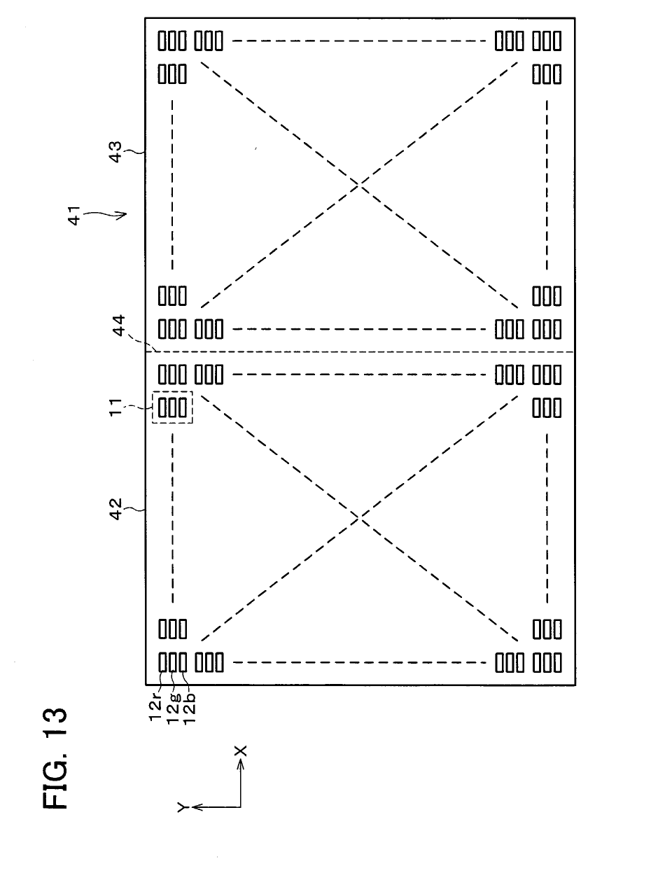

Next, description is given as to a liquid crystal display device, a multipanel type display device in which wide area display is realized by connecting two adjacent liquid crystal display panels. Further, the liquid crystal display device performs color display. As shown in FIG. 13, the display device is a direct view type display device 41 in which two adjacent display panels connected to each other from side to side (left side display panel 42, right side display panel 43) are disposed on the same plane. That is, in the display device 41 arranged in the foregoing manner, it is possible for an observer to see image information displayed on the two right and left display panels 42 and 43 by causing the display panel to modulate light which has been irradiated from a back side to the display panel. Note that, such a reflective display device that the observer can see image information by causing the display panel to modulate reflected light of ambient light which has been projected from a surface side to the display panel may be used.

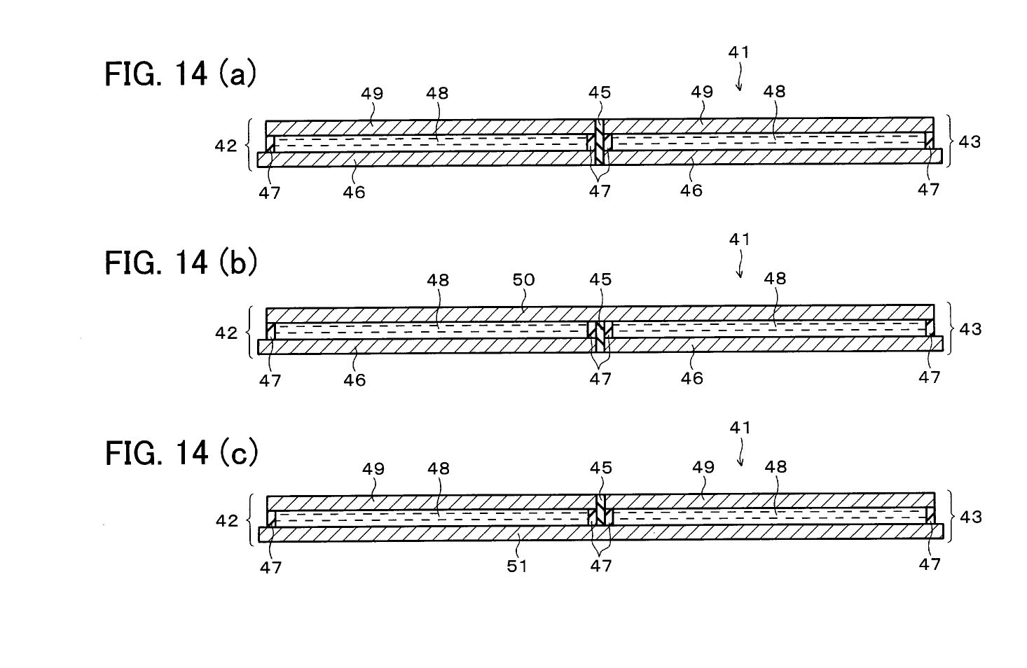

As shown in FIG. 14(a), the two right and left display panels 42 and 43 are arranged so that: the active matrix substrate 46 and a counter substrate 49 are bonded to each other by a sealing member 47 provided so as to seal respective peripheral portions like a frame, and liquid crystal 48, a display medium, is provided in a gap between both the substrates. Note that, since a basic structure of the respective display panels is the same as that of a known active matrix type liquid crystal panel, detail description is omitted.

As shown in FIG. 13, the liquid crystal display device is arranged so that many unit pixels 11 are disposed. In this case, the unit pixel 11 has three color pixels corresponding to three elementary colors required in color display: red (R), green (G), and blue (B). Here, in the display device of FIG. 13, plural color pixels disposed in the unit pixel 11 are aligned along a seam line 44 between the right and left display panels. Of course, the number of color pixels in the unit pixel is not limited to three, but the number of the color pixels may be two or four according to the display panel's ability for expressing colors. Further, the three elementary colors are not limited to red, green, blue, but may be cyan, magenta, and yellow.

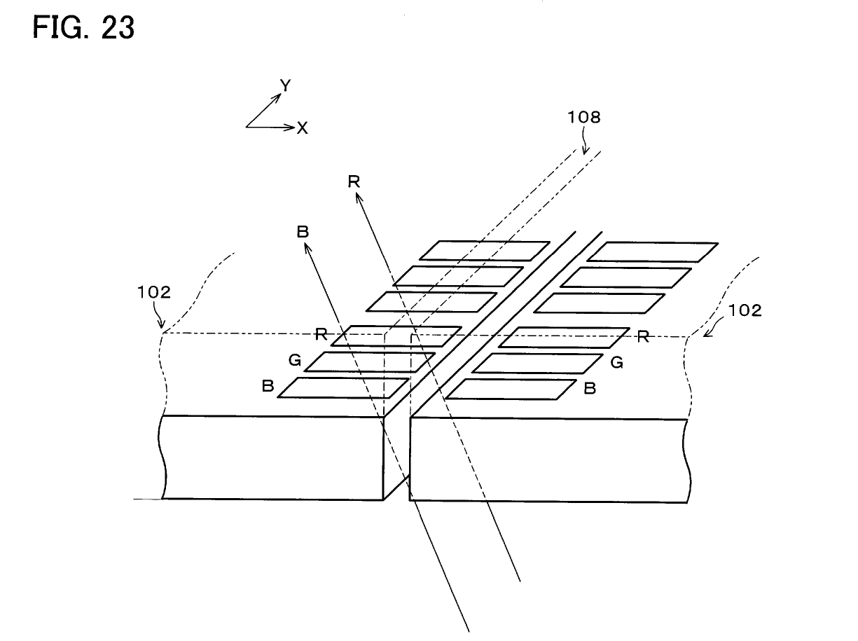

Thus, as shown in FIG. 23 showing a prior art, a distance from the seam line 44 to the respective color pixels (R), (G), and (B) is uniformed. Thus, in a case where the seam between the liquid crystal panels is diagonally observed, the seam line 44 overlaps with all the color pixels (R), (G), and (B) under the same condition. Therefore, even though display color is a little spoiled by the seam line 44, this does not spoil a color balance. As a result, it becomes possible to greatly improve such a conventional problem that: the vicinity of the seam 44 is colored like a rainbow depending on the observer's position (observation angle).

According to the present invention, the above-mentioned active matrix substrate can be employed in a multipanel type display device whose seam is not obvious. When the above-mentioned active matrix substrate is used, it is possible to dispose scanning lines and signal lines so that plural electrodes in a unit pixel are aligned along a seam line between display panels which exists in Y direction, under such a condition that the scanning lines and the signal lines are disposed in an ordinary direction (that is, the scanning lines are disposed in a horizontal direction with respect to a screen (widthwise, X direction in the figure, first direction), and the signal lines are disposed in an up-and-down direction (vertical direction, Y direction in the figure, second direction)). As a result, it becomes possible to readily realize a multipanel type display device in which the seam shown in FIG. 13 is not obvious.

Further, since directions in which the scanning lines and the signal lines are disposed are the same as in an ordinary display panel, a converting circuit for image format is not required unlike a conventional multipanel type display device (prior art 2).

Note that, the display device of the present invention may be arranged by using complex substrates constituted of either of the active matrix substrates 46 or the counter substrates 49 which are combined with their counterparts, that is, the device of the present invention may be arranged as shown in FIG. 14(b) or FIG. 14(c). That is, in an example shown in FIG. 14(a), the display panels 42 and 43 have the active matrix substrate 46 and the counter substrate 49 respectively, and the display panels are combined with each other via a seam 45. In an example shown in FIG. 14(b), two active matrix substrates are combined with each other with respect to a single counter substrate 50. Further, in an example shown in FIG. 14(c), two counter substrates 49 are combined with each other with respect to a single active matrix substrate 51.

In addition, the display device of the present invention may be arranged so that there is provided a support substrate, which reinforces the seam between the display panels, outside the active matrix substrate and the counter substrate shown in FIG. 14(a), FIG. 14(b), and FIG. 14(c). Further, a display medium is not limited to liquid crystal, but the idea of the display device of the present invention can be applied to other display devices such as an EL display and an electrophoresis display.

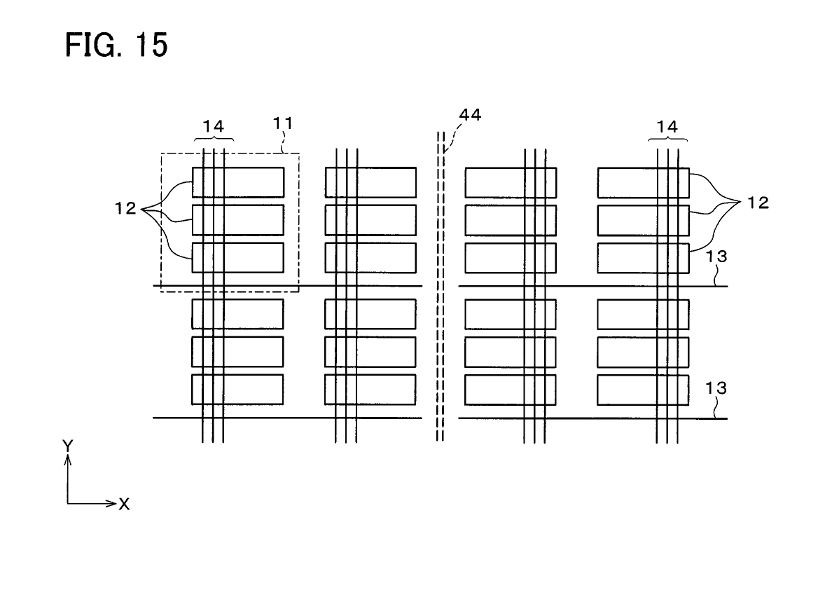

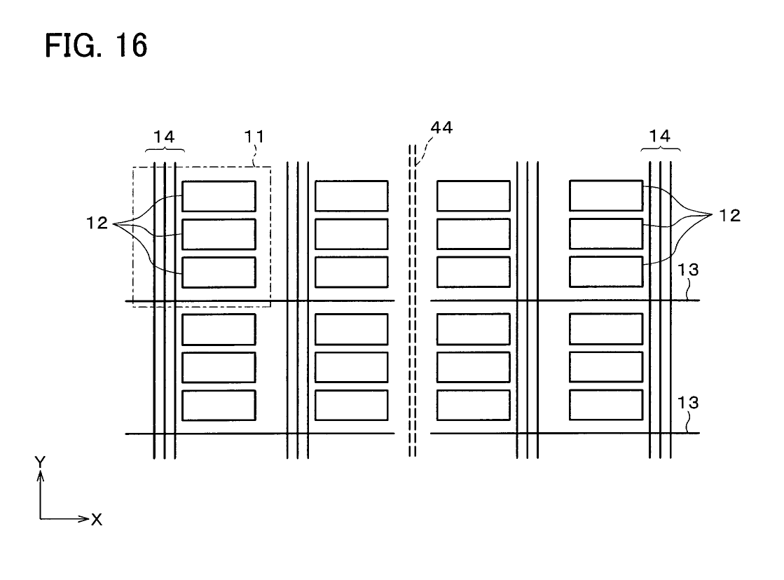

Next, a preferable example of the display device is shown. FIG. 15 and FIG. 16 are enlarged plan views showing the vicinity of a seam line 44 in a display panel having the multipanel structure. Here, an active matrix substrate, in which plural signal lines 14 of the unit pixel 11 are unevenly distributed in the unit pixel, is used. That is, the active matrix substrate shown in FIG. 4 is used in a display device of FIG. 15, and the active matrix substrate shown in FIG. 8 (or FIG. 10) is used in a display device of FIG. 16. Further, there are provided right and left active matrix substrates with the seam line 44 between display panels (or active matrix substrates), and there are unevenly distributed the plural signal lines 14 in the unit pixel so that the signal lines 14 exist away from the seam line 44, and there exist no signal lines in the vicinity of the seam line.

Generally, in a case where a high definition display device is to be manufactured by using the multipanel structure (FIG. 14(a)) and the complex active matrix substrate (FIG. 14(b)), it is required to cut a side which serves as the seam line with high accuracy. In this case, it is required to cut and rub using a dicing cutter and a laser cutter upon processing the cut side of the display panel and the active matrix substrate with high accuracy. However, a minute chip tends to occur at an angle of a substrate edge upon cutting and rubbing the side. If there exists a signal line in the vicinity of the cut end of the active matrix substrate, the chip brought about at a corner of the substrate edge disconnects the signal line. In a case where a pixel electrode is partially chipped, the damage is, at most, a point defect in which only the pixel is spoiled. While, in a case where the signal line is disconnected, the damage is a line defect in which all the pixels connected to the signal line are spoiled. Compared with the point defect, the line defect is extremely outstanding, so that the line defect leads to a serious defect in a display device.

On the other hand, the display device shown in FIG. 15 and FIG. 16 is arranged so that the signal lines are unevenly distributed away from the seam line 44 between the display panels, so that this brings about such an advantage that there hardly occurs the line defect which results from cutting and rubbing a substrate. In practice, the right and left active matrix substrates may be designed so that: the wiring layout is line-symmetrically provided with respect to the seam line 44 as a center, or the wiring layout is point-symmetrically provided with respect to a central portion of the seam line 44 as a center, while having an idea of the wiring layout realized in the active matrix substrate of FIG. 16, or FIG. 8 (FIG. 10).

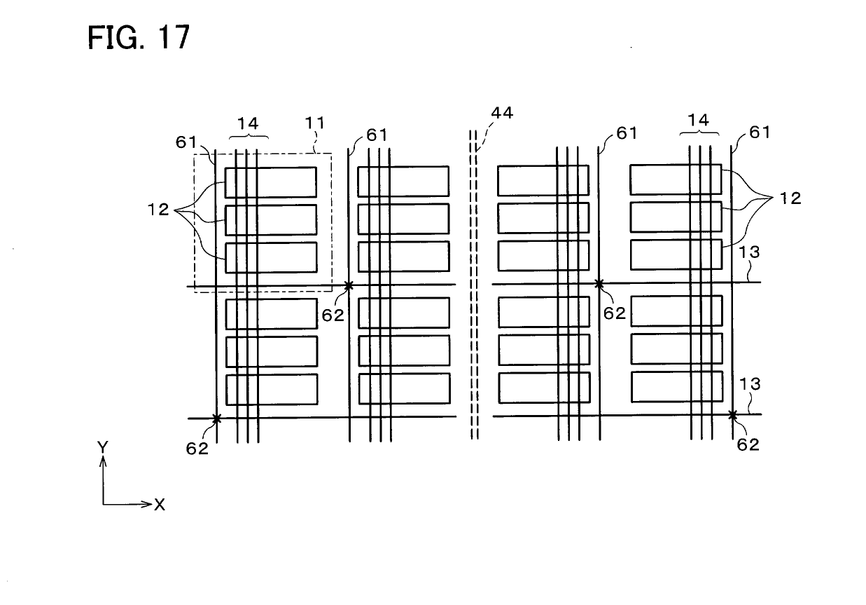

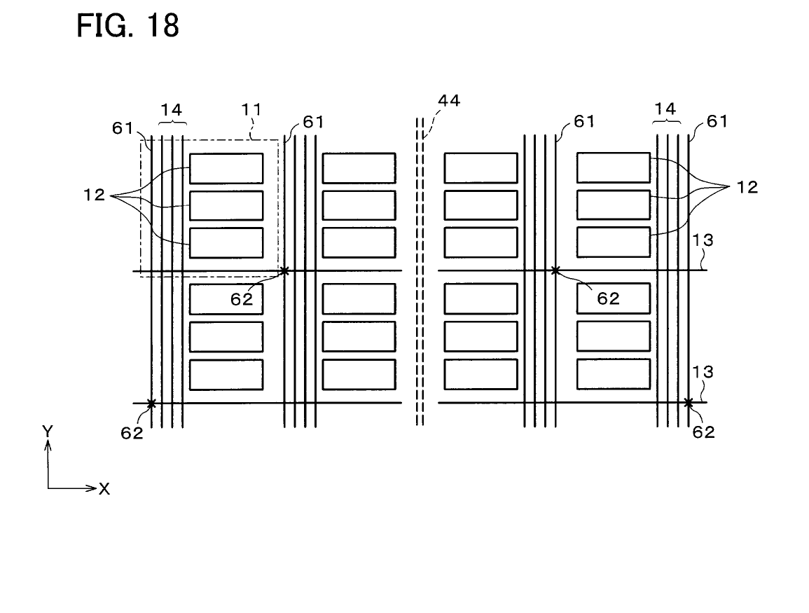

FIG. 17 and FIG. 18 are enlarged plan views showing the vicinity of the seam line 44 in a display panel, having the multipanel structure, which is a modification example of the foregoing arrangement. Here, an active matrix substrate, in which plural signal lines of the unit pixel 11 are unevenly distributed in the unit pixel 11, is used, and there is provided a single scanning-line drawing line 61 for each unit pixel. The scanning-line drawing line 61 is electrically connected to the scanning line 13, disposed in X direction, at a contact portion 62 indicated by an asterisk in the figure. Further, it is possible to input a drive signal from the scanning-line drawing line 61 to the scanning line 13. Thus, it is possible to input the drive signal from a single direction (for example, a lower side of the figure) to the signal line 14 and the scanning line 13, so that only one side of four sides constituting a rectangle of the display panel can be used as a signal input side. Thus, other three sides are unused, so that it is possible to readily realize a multipanel type display device in which the three sides can be used as connection sides.

Note that, the active matrix substrate of the present invention is not limited to only the above-mentioned display devices. The active matrix substrate of the present invention can be used as follows: for example, there are additionally provided a photo diode (pin joint structure, MIS joint structure, Schottky joint structure, and the like) and a photo conductive film (a-Si film, a-Se film, CdSe film, organic photo conductive film, and the like) corresponding to the respective pixel electrodes of the active matrix substrate, and a voltage detector or a charge detector is connected to an end of the signal line at an external portion of the active matrix substrate, so that it is also possible to use an active matrix array as a two-dimensional image data readout circuit (two-dimensional image detector).

Thus, in a case where the two-dimensional image detector is a detector (imaging device) which picks up color images by using color filters of R, G, and B (or, C, M, and Y) together corresponding to the plural pixel electrodes in the unit pixel, the structure of the active matrix substrate of the present invention is effective. That is, since the pixel electrodes corresponding to R, G, and B are disposed along the seam between the active matrix substrates, it is possible to avoid the deformation if the color balance which results from the seam between the active matrix substrates.

For example, the active matrix substrates of the present invention may be connected to each other as detection panels for color detection in a disposing direction of the scanning line.

In this case, the plural pixel electrodes in the unit pixel in the active matrix substrate are provided so as to correspond to respective colors for color detection.

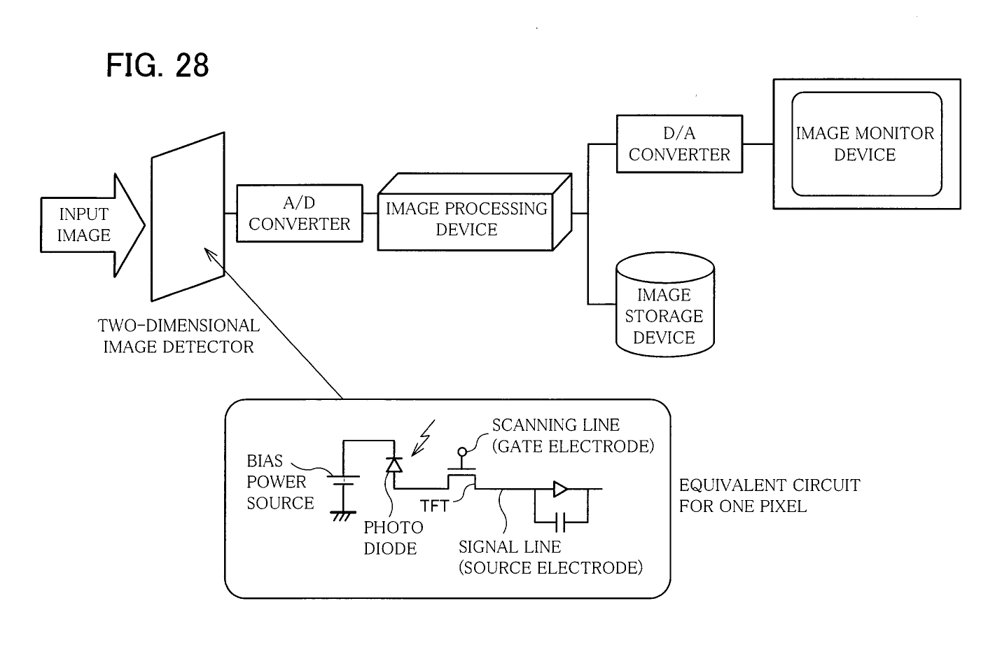

Here, FIG. 28 shows an example of a schematic block diagram in a case where the active matrix substrate of the present invention is used in a two-dimensional image detector.

In FIG. 28, there is provided a photodiode on each pixel so as to detect input images. Further, light striking the photo diode, that is, light as an input image is converted into an analog electronic signal according to light intensity, so as to output the converted electronic signal to the outside of the active matrix substrate.

The analog electronic signal outputted from the active matrix substrate is converted into a digital signal by an A/D converter, so as to transmit the converted digital signal to an image processing device of the following stage. In the image processing device, a predetermined process is performed with respect to a digital signal, and a converted signal is transmitted to a D/A converter and an image storage device.

The digital signal transmitted to the D/A converter is converted into an analog signal, so as to transmit the converted analog signal to a monitor device. In this manner, an image which extremely resembles the input image is displayed on the image monitor device.

Note that, the active matrix substrate of the present invention can be used as an active matrix substrate of a single panel having no seam. Besides, the active matrix substrate can be used also in a display device or a detector that does not use a color filter (for example, a display device or detector of monochrome).

In addition, an active matrix substrate having a photodiode or a photoconductive film is used in combination with a scintillator or a sensitization film, so that it is possible to realize an X ray detector (X ray imaging device).

As described above, the active matrix substrate of the present invention is constituted of unit pixels each of which is provided on a crossing point between a scanning line and each of signal lines in a matrix manner via each of switching elements, and the unit pixel includes pixel electrodes which conduct in combination with the signal lines that correspond to the pixel electrodes when the switching element is ON by applying a scanning signal to the scanning line, and the active matrix substrate includes (a) a first layer having the scanning line, the signal lines, and the switching element, and (b) a second layer having the pixel electrodes, aligned along a disposing direction of the signal lines, which are insulated from (i) a scanning-line-side terminal and a signal-line-side terminal of the switching element, (ii) the scanning line, and (iii) the signal lines, and the second layer is provided above the first layer, wherein between the first layer and the second layer, there is provided a connection section for electrically connecting each of the pixel electrodes to a pixel-electrode-side terminal of the switching element that corresponds to the pixel electrode.

Further, the active matrix substrate of the present invention may be arranged so that the active matrix substrate is constituted of unit pixels each of which is provided on a crossing point between a scanning line and each of signal lines in a matrix manner via each of switching elements, and the unit pixel includes pixel electrodes which conduct in combination with the signal lines that correspond to the pixel electrodes when the switching element is ON by applying a scanning signal to the scanning line, and the active matrix substrate includes at least (a) a first layer having a connection electrode constituted of an extended portion of a pixel-electrode-side terminal of the switching element, and (b) a second layer having the pixel electrodes aligned along a disposing direction of the signal lines, wherein between the first layer and the second layer, there is provided an interlayer insulating film for insulating the first and second layers from each other, and in the interlayer insulating film, there is provided a connection section for electrically connecting each of the pixel electrodes of the second layer to the connection electrode of the first layer.

Further, the active matrix substrate of the present invention may be arranged so that the active matrix substrate is constituted of unit pixels each of which is provided on a crossing point between a scanning line and each of signal lines in a matrix manner via each of switching elements, and the unit pixel includes pixel electrodes which conduct in combination with the signal lines that correspond to the pixel electrodes when the switching element is ON by applying a scanning signal to the scanning line, wherein in the unit pixel, there are provided the pixel electrodes along a disposing direction of the signal lines, and at least two of the signal lines are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges the signal lines.

Further, the active matrix substrate of the present invention may be arranged so that the active matrix substrate includes a plurality of unit pixels disposed in a matrix manner, wherein each of the unit pixels includes at least: a scanning line disposed along a first direction (X direction); a plurality of signal lines disposed along a second direction (Y direction) which crosses the first direction; a plurality of switching elements, connected to the scanning line, which are provided so as to correspond to the respective signal lines; an interlayer insulating film that is provided on the scanning line, the signal lines, and the switching elements; a plurality of pixel electrodes that are made ON/OFF by the switching elements so as to or not to conduct to the signal lines; and a plurality of contact holes, provided in the interlayer insulating film so as to correspond to the respective pixel electrodes, which connect the switching elements to the pixel electrodes, wherein a distance between the contact holes and the scanning line is different for each of the contact holes in the unit pixel.

Beside the foregoing arrangement, the active matrix substrate of the present invention may be arranged so that: in the unit pixel, the signal lines are unevenly distributed so that a center of the pixel electrode in a direction of the scanning line is a borderline.

According to the arrangement, in each unit pixel, the signal lines disposed in the unit pixel are unevenly distributed so that a center of the pixel electrode in a direction of the scanning line is a borderline.

Beside the foregoing arrangement, the active matrix substrate of the present invention may be arranged so that: the signal lines disposed in the unit pixel exist at only one area of two areas divided by the border line.

According to the arrangement, the signal lines disposed in each unit pixel exist at only one area of two areas divided by the borderline.

Note that, in this case, the signal lines can be arranged to be or not to be superposed with the pixel electrodes. That is, in each unit pixel, it is possible to divide an area which partially includes the signal lines into two areas: for example, an area, having the signal lines, which extends from one end of each unit pixel in a direction of the scanning line to a borderline, for example, to a center of the pixel electrode in a direction of the scanning line, and an area, having no signal lines, which extends from the other end of the unit pixel in a direction of the scanning line to the borderline. Further, for example, in each unit pixel, it is possible to divide each pixel electrode into two areas: an area, extending from one end of the pixel electrode in a direction of the scanning line to a borderline, for example, to a center of the pixel electrode in a direction of the scanning line, with which the signal lines are superposed, and an area, extending from the other end of the pixel electrode in a direction of the scanning line to the borderline, with which the signal lines are superposed.

According to the arrangement, one end of the pixel electrode in a direction of the scanning line is the area in which the signal lines exist, and the other end of the pixel electrode in a direction of the scanning line is the area in which the signal line do not exist. In other words, the signal lines in the unit pixel are unevenly disposed in the unit pixel so that the signal lines are away from a connection edge between the display panels in a case of forming a multipanel type display device in which the active matrix substrates are connected to each other as display panels.

Generally, in a case of forming a multipanel type display device in which active matrix substrates are connected to each other as display panels, there is a risk that elements in the vicinity of a seam are accidentally broken or cut due to fragments brought about upon cutting or rubbing a seam line with high accuracy so as to combine the active matrix substrates with each other.

On the other hand, in a case of forming the multipanel type display device in which the active matrix substrates of the foregoing arrangement are combined with each other in a disposing direction of the scanning line (crosswise), in each unit pixel, the seam between the active matrix substrates is positioned on the side portion having no signal line, so that the signal line does not exist in the vicinity of the seam.

Thus, it is possible to reduce the risk that the signal lines are accidentally broken or cut due to fragments brought about upon cutting or rubbing a seam line with high accuracy so as to combine the active matrix substrates with each other.

Therefore, besides the effect realized by the foregoing arrangement, it is possible to effectively prevent continuity defect brought about by disconnection of the signal lines in a case of forming the multipanel type display device in which the active matrix substrates are combined with each other in a disposing direction of the scanning line (crosswise).

Further, besides the foregoing arrangement, the active matrix substrate of the present invention may be arranged so that: in each unit pixel, at least one signal line is superposed with all the pixel electrodes in a flat manner via the interlayer insulating layer provided on the scanning line, the signal lines, and the switching elements.

In addition, besides the foregoing arrangement, the active matrix substrate of the present invention may be arranged so that: at least one signal line of the signal lines in the unit pixel is positioned so as no to be superposed with the pixel electrodes.

According to the arrangement, at least one of the signal lines in the unit pixel is positioned so as not to be superposed with the pixel electrodes. For example, either or both of the signal lines positioned on both ends of the plural signal lines in the unit pixel is/are positioned so as not to be superposed with the pixel electrodes. For example, if the number of the signal lines in the unit pixel is three, either of right and left signal lines is not superposed with the pixel electrodes, and the other signal line and a central signal line are superposed with the pixel electrodes. Alternately, the right and left signal lines are not superposed with the pixel electrodes, and only the central signal line is superposed with the pixel electrodes. In other words, seen from a vertical direction with respect to an electrode surface of the pixel electrode, at least one signal line is disposed on at least one end in a direction of the scanning line, having no pixel electrode, of the unit pixel. In a case where the signal lines are disposed on both ends in a direction of the scanning line, seen from a vertical direction with respect to the electrode surface of the pixel electrode, the pixel electrode is disposed between the signal lines.

Thus, other members do not blank the pixel electrode by an area which would be occupied by the signal lines positioned at both ends of the unit pixel. Thus, besides the effect realized by the foregoing arrangement, it is possible to raise an aperture ratio since the area which would be occupied by the signal lines remains unoccupied.

Further, the signal lines positioned at both ends can be disposed on a portion having no pixel electrode (non-display area), for example, on a light shielding area (black matrix). Therefore, besides the effect realized by the foregoing arrangement, it is possible to obtain such an advantage that the non-display area can be used effectively.

In addition, besides the foregoing arrangement, the active matrix substrate of the present invention may be arranged so that: the switching element is superposed with a corresponding pixel electrode.

According to the arrangement, the switching element is superposed with a corresponding pixel electrode.

Thus, each pixel electrode can serve as an electrical shield with respect to each switching element. Therefore, besides the effect realized by the foregoing arrangement, it is possible to electrically protect the respective switching elements without additionally providing a special member.

Besides the foregoing arrangement, the active matrix substrate of the present invention may be arranged so that: in the unit pixel, each of the pixel electrodes other than the one closest to the scanning line is electrically connected to the scanning line via a wire provided under those pixel electrodes intervening between that pixel electrode and the scanning line, and the pixel electrode provided further from the scanning line has a shorter length in a direction of the signal line so that all the pixel electrodes will have same aperture ratios.

According to the arrangement, in the unit pixel, the further the pixel electrode is positioned from the scanning line, the shorter the pixel electrode is in a direction of the signal line, in other words, the narrower the width of the pixel electrode is in a direction of the scanning line so that aperture ratios of all the pixel electrodes are equalized.

When each of the pixel electrodes is electrically connected to the scanning line via a portion under those pixel electrodes intervening between that pixel electrode and the scanning line, in other words, via a member wired through an area superposed with those pixel electrodes, an aperture ratio decreases by the area occupied superposed with those pixel electrodes. Then, as the pixel electrode is positioned nearer to the scanning line, in other words, the pixel electrode has wider area for connecting those pixel electrodes to the scanning line, it is possible to prevent the decrease in the aperture ratio of the pixel electrode more effectively by setting an area of the pixel electrode to be wide in advance.

Thus, the aperture ratios of all the pixel electrodes in the unit pixel are equalized. Therefore, besides the effect realized by the foregoing arrangement, it is possible to prevent uneven brightness effectively.

Besides the foregoing arrangement, the active matrix substrate of the present invention may be arranged so that: at least two of the signal lines in the unit pixel are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges the signal lines.

According to the arrangement, at least two signal lines of the plural signal lines in the unit pixel, positioned so as not to be superposed with the pixel electrode, are disposed at one-end portion of the unit pixel in a direction of the scanning line. In other words, in a in-plane direction of the electrode surface of the pixel electrode, at least two signal lines are disposed at the one-end portion, having no pixel electrode, of the unit pixel in a direction of the scanning line. For example, at least two signal lines may be positioned at the one-end portion of the unit pixel in a direction of the scanning signal, and at least one signal line may be positioned at the other end in a direction of the scanning line, or at an area where the signal line is superposed with the pixel electrode. Alternately, all the signal lines may be positioned at only one-end portion of the unit pixel in a direction of the scanning line.

Thus, other members do not blank the pixel electrode by an area which would be occupied by the signal lines positioned at both ends of the unit pixel. Thus, besides the effect realized by the foregoing arrangement, it is possible to raise an aperture ratio since the area which would be occupied by the signal lines remains unoccupied.

Particularly, by providing the bypass electrode, it is possible to dispose the plural signal lines at an area, positioned at the other end of the unit pixel in a direction of the scanning line, in which the signal line is not superposed with the pixel electrode, so that an area in which the signal line is not superposed with the pixel electrode increases by an area occupied by the signal lines. Thus, it is possible to raise the aperture ratio of the unit pixel by the area occupied by the signal lines.

Further, it is possible to dispose the signal lines at the both ends so as to be positioned at a portion having no pixel electrode (non-display area), for example, a light shielding area (black matrix). Therefore, besides the effect realized by the foregoing arrangement, it is possible to use the non-display area efficiently.

Besides the foregoing arrangement, the active matrix substrate of the present invention may be arranged so that: the bypass electrode is provided by using the same material and process as in the pixel electrode.

According to the arrangement, the bypass electrode is provided by using the same material and process as in the pixel electrode. Therefore, besides the effect realized by the foregoing arrangement, it is possible to raise the aperture ratio of the unit pixel without using a complicated process.

Besides the arrangement, the active matrix substrate of the present invention may be arranged so that: there is provided a redundant wiring that electrically connects one portion to the other portion of the signal line so as to be short-circuited.

According to the arrangement, there is provided a redundant wiring that electrically connects one portion to the other portion of the single signal line so as to be short-circuited.

Thus, in a case where the signal line is disconnected between the two portions with the redundant wiring therebetween, the continuity of them can be kept by the redundant wiring. Therefore, besides the effect realized by the foregoing arrangement, it is possible to keep a desirable condition of the electrical connection even though the signal line is disconnected.

Besides the arrangement, the active matrix substrate of the present invention may be arranged so that: the redundant wiring is provided by using the same material and process as in the pixel electrode.

According to the arrangement, the active matrix substrate of the present invention may be arranged so that: the redundant wiring is provided by using the same material and process as in the pixel electrode. Therefore, besides the effect realized by the foregoing arrangement, it is possible to prevent the continuity defect brought about by the disconnection of the signal line without using a complicated process.

Besides the arrangement, the active matrix substrate of the present invention may be arranged so that: there are provided scanning-line-drawing wires, provided along a disposing direction of the signal lines, that are electrically connected to the scanning line.

According to the arrangement, there are provided scanning-line-drawing lines, provided along a disposing direction of the signal line, that are electrically connected to the scanning line.

Thus, in a rectangle active matrix substrate, it is possible to transmit a signal between the scanning line and the outside, for example, it is possible to apply a scanning signal to the scanning line, via the scanning-line drawing line, at an edge where an end of the signal line exists. As a result, at three edges other than the foregoing edge, there is not a terminal, provided on wirings such as the signal line and the scanning line, which performs the signal transmission with respect to the outside, for example, a terminal etc. for internally applying a signal. Therefore, besides the effect realized by the foregoing arrangement, it is possible to use the three edges as seams in a case of manufacturing a multipanel type display device in which a plurality of rectangle display panels are combined with each other.

Further, the active matrix substrate of the present invention can be arranged so that: the active matrix substrate includes a plurality of unit pixels disposed in a matrix manner, wherein each of the unit pixels includes at least: (1) a scanning line disposed along a first direction (X direction); (2) a plurality of signal lines disposed along a second direction (Y direction) which crosses the first direction; (3) a plurality of switching elements, connected to the scanning line, which are provided so as to correspond to the respective signal lines; (4) an interlayer insulating film that is provided on the scanning line, the signal lines, and the switching elements; (5) a plurality of pixel electrodes, aligned along the second direction (Y direction), which are provided so as to correspond to the respective signal lines; and (6) a plurality of contact holes, provided in the interlayer insulating film so as to correspond to the respective pixel electrodes, which connect the switching elements to the pixel electrodes.

Further, the active matrix substrate of the present invention can be arranged so that: a distance between the contact holes and the scanning line is different for each of the contact holes in the unit pixel.

In addition, the active matrix substrate of the present invention can be arranged so that: in the unit pixel, at least one of the signal lines is superposed with all the pixel electrodes in a flat manner via the interlayer insulating film.

According to the arrangement, it is possible to set an aligning direction of the pixel electrodes in the unit pixel according to the disposing direction of the signal lines without changing conventional directions in which the scanning line and the signal lines are disposed.

Further, the active matrix substrate of the present invention can be arranged so that: in the unit pixel, widths in the first direction of the respective pixel electrodes differ so as to be larger as each of the pixel electrodes is positioned further from the scanning line electrode.

According to the arrangement, it is possible to substantially equalize all aperture ratios of the pixel electrodes in the unit pixel.

Further, the active matrix substrate of the present invention can be arranged so that: in the unit pixel, at least one of the signal lines is electrically connected to the switching element by a bypass electrode provided in the interlayer insulating film.

According to the arrangement, it is possible to set an aligning direction of the pixel electrodes in the unit pixel according to the disposing direction of the signal lines without changing conventional directions in which the scanning line and the signal lines are disposed.

Further, the active matrix substrate of the present invention can be arranged so that: there is provided a redundant electrode, which keeps connection when disconnection of the signal lines occurs, in the interlayer insulating film so as to exist along an area in which the signal lines are disposed.

According to the arrangement, it is easy to avoid defect brought about the disconnection of the signal lines.

Further, the active matrix substrate of the present invention can be arranged so that: the bypass electrode and/or the redundant electrode are provided by using the same material and process.

According to the arrangement, it is convenient that the bypass electrode and/or the redundant electrode are provided without using an additional process.

Further, the active matrix substrate of the present invention can be arranged so that: there is further provided an auxiliary capacitance line under the interlayer insulating film.

Further, the active matrix substrate of the present invention can be arranged so that: one of scanning lines adjacent to each other serves as the auxiliary capacitance line.

According to the arrangement, it is possible to suitably use the active matrix substrate as an active matrix substrate provided in, for example, a liquid crystal display device and an image detector both of which require auxiliary capacitance.

Further, the display of the present invention may be arranged so that: the active matrix substrates are connected to each other in a disposing direction of the scanning line (crosswise) as display panels, and the pixel electrodes in the unit pixel correspond to respective colors for color display.

Further, the display device of the present invention may be arranged so that: a display device includes: one or more active matrix substrates described above; one or more counter substrates; and one or more display media provided between the active matrix substrates and the counter substrates, wherein in a case where the active matrix substrates are provided in plurality, the active matrix substrates are connected to each other in a disposing direction (crosswise) of the scanning line, and in a case where the counter substrates are provided in plurality, the counter substrates are connected to each other in the disposing direction of the scanning line, and the pixel electrodes in the unit pixel correspond to respective colors for color display, and the active matrix substrates and/or the counter substrates are provided in plurality.

Besides the arrangement, the display device of the present invention may be arranged so that: in the unit pixel adjacent to a connection edge of each of the display panels, the signal lines disposed in the unit pixel exist at only one side positioned away from the connection edge so that a center of the pixel electrodes in a direction of the scanning line is a border line.

Generally, in a case of forming a multipanel type display device in which active matrix substrates are combined with each other as display panels, there occurs a risk that elements in the vicinity of a seam are accidentally broken or cut by fragments brought about upon cutting and rubbing a seam line with high accuracy so as to combine the active matrix substrates.

On the other hand, according to the foregoing arrangement, no signal line exists in the vicinity of the seam line between the display panels. Thus, it is possible to reduce the risk that the signal lines are accidentally cut by fragments brought about upon cutting and rubbing the seam line with high accuracy so as to combine the active matrix substrates. Therefore, besides the effect realized by the foregoing arrangement, it is possible to prevent the continuity defect brought bout by the disconnection of the signal lines in a case of forming the multipanel type display device in which the active matrix substrates are combined with each other in a disposing direction of the scanning line (crosswise) as display panels.

Further, it is possible to arrange a multipanel type display device having a structure in which counter substrates are combined with the active matrix substrates respectively, and the active matrix substrates combined with the counter substrates are connected to each other. Alternately, it is also possible to arrange a multipanel type display device having a structure in which active matrix substrates are combined with each other, and a single counter substrate which is large enough to cover an entire display panel constituted of the combined active matrix substrates is provided opposite to the display panels.

Further, the display device of the present invention can be arranged so that: display panels, each of which has either of the foregoing active matrix substrates, are aligned so that display surfaces of the display panel constitute a single plane, and ends of the display panel are connected to each other along the second direction, wherein the second direction is a vertical direction with respect to a display image, and the pixel electrodes provided in the unit pixel correspond to colors required in color display.

According to the arrangement, by realizing a multipanel type display device using the preferable active matrix substrate by which the problems shown in prior arts (1), (2), and (3) are solved, it is possible to readily make the seam indistinctive.

Further, the display device of the present invention can be arranged so that: in the unit pixel of the active matrix substrate, the signal lines are unevenly distributed so as to be away from the connection side between the display panels.

Thus, it is possible to avoid the disconnection of the signal lines upon processing the connection edge of the display panel with high accuracy.

Further, the display device of the present invention can be arranged so that: in the display panels each of which has one or more display media between one or more active matrix substrates and one or more counter substrates described above, in a case where the active matrix substrates are provided in plurality, the active matrix substrates are aligned so that display surfaces of the active matrix substrates constitute a single surface and connected to each other at their ends along the second direction, and in a case where a the counter substrates are provided in plurality, the counter substrates are aligned so that display surfaces of the counter substrates constitute a single surface and connected to each other at their ends along the second direction, and the active matrix substrates and/or the counter substrates are provided in plurality, wherein the second direction is an up-and-down direction with respect to a display image, and the pixel electrodes provided in the unit pixel correspond to colors required in color display.

According to the arrangement, by realizing a complex substrate display device using the preferable active matrix substrate by which the problems shown in prior arts (1), (2), and (3) are solved, it is possible to readily make the seam indistinctive.

Further, the display device of the present invention can be arranged so that: in the unit pixel of the active matrix substrate, the signal lines are unevenly distributed so as to exist away from a connection edge of the active matrix substrate and/or the counter substrate.

Thus, it is possible to avoid the disconnection of the signal lines upon processing the connection side of the substrate with high accuracy.

Further, the display device of the present invention may be arranged so that: the active matrix substrates connected to each other in a disposing direction of the scanning line as detection panels for color detection, wherein the pixel electrodes in the unit pixel of the active matrix substrate correspond to respective colors for color detection.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An active matrix substrate constituted of unit pixels each of which is provided on a crossing point between a scanning line and each of signal lines in a matrix manner via each of switching elements, the unit pixel including pixel electrodes which conduct in combination with the signal lines that corresponds to the pixel electrodes when the switching element is ON by applying a scanning signal to the scanning line,
the active matrix substrate comprising at least (a) a first layer having a connection electrode constituted of an extended portion of a pixel-electrode-side terminal of the switching element, and (b) a second layer having the pixel electrodes aligned along a disposing direction of the signal lines, wherein
between the first layer and the second layer, there is provided an interlayer insulating film for insulating the first and second layers from each other, and in the interlayer insulating film, there is provided a connection section for electrically connecting each of the pixel electrodes of the second layer to the connection electrode of the first layer.

2. The active matrix substrate as set forth in claim 1, wherein in the unit pixel, the signal lines are unevenly distributed so that a center of the pixel electrode in a direction of the scanning line is a borderline.

3. The active matrix substrate as set forth in claim 2, wherein the signal lines disposed in the unit pixel exist at only one area of two areas divided by the border line.

4. The active matrix substrate as set forth in claim 1, wherein in the unit pixel, at least one of the signal lines is superposed with all the pixel electrodes in a flat manner via the interlayer insulating film that is provided on the scanning line, the signal lines, and the switching elements.

5. The active matrix substrate as set forth in claim 1, wherein at least one of the signal lines provided in the unit pixel is positioned so as not to be superposed with the pixel electrodes.

6. The active matrix substrate as set forth in claim 1, wherein the switching element is superposed with each of the pixel electrodes that corresponds to the switching element.

7. The active matrix substrate as set forth in claim 1, wherein in the unit pixel,
each of the pixel electrodes other than the one closest to the scanning line is electrically connected to the scanning line via a wire provided under those pixel electrodes intervening between that pixel electrode and the scanning line, and
the pixel electrode provided further from the scanning line has a shorter length in a direction of the signal line so that all the pixel electrodes will have same aperture ratios.

8. The active matrix substrate as set forth in claim 1, wherein:
at least two of the signal lines in the unit pixel are disposed on one-end portion of the unit pixel in a direction of the scanning line so as not to be superposed with the pixel electrodes, and
each of the signal lines, connected to each of the pixel electrodes so as to sandwich those signal lines intervening between the signal line and the pixel electrode, is connected to the switching element via a bypass electrode that bridges the signal lines.

9. The active matrix substrate as set forth in claim 8, wherein the bypass electrode is formed by using same material and process as in the pixel electrode.

10. The active matrix substrate as set forth in claim 1, wherein there is provided a redundant wiring that electrically connects one portion to an other portion of the signal line so as to be short-circuited.

11. The active matrix substrate as set forth in claim 10, wherein the redundant wiring is formed by using same material and process as in the pixel electrode.

12. The active matrix substrate as set forth in claim 1, wherein there are provided scanning-line-drawing wires, provided along a disposing direction of the signal lines, that are electrically connected to the scanning line.

13. An active matrix substrate constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line, wherein
in the unit pixel, there are provided the pixel electrodes along a disposing direction of the signal lines, and at least two of the signal lines are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges the signal lines.

14. The active matrix substrate as set forth in claim 13, wherein in the unit pixel, the signal lines are unevenly distributed so that a center of the pixel electrode in a direction of the scanning line is a borderline.

15. The active matrix substrate as set forth in claim 14, wherein the signal lines disposed in the unit pixel exist at only one area of two areas divided by the border line.

16. The active matrix substrate as set forth in claim 13, wherein in the unit pixel, at least one of the signal lines is superposed with all the pixel electrodes in a flat manner via the interlayer insulating film that is provided on the scanning line, the signal lines, and the switching elements.

17. The active matrix substrate as set forth in claim 13, wherein at least one of the signal lines provided in the unit pixel is positioned so as not to be superposed with the pixel electrodes.

18. The active matrix substrate as set forth in claim 13, wherein the switching element is superposed with each of the pixel electrodes that corresponds to the switching element.

19. The active matrix substrate as set forth in claim 13, wherein in the unit pixel,
each of the pixel electrodes other than the one closest to the scanning line is electrically connected to the scanning line via a wire provided under those pixel electrodes intervening between that pixel electrode and the scanning line, and
the pixel electrode provided further from the scanning line has a shorter length in a direction of the signal line so that all the pixel electrodes will have same aperture ratios.

20. The active matrix substrate as set forth in claim 13, wherein the bypass electrode is formed by using same material and process as in the pixel electrode.

21. The active matrix substrate as set forth in claim 13, wherein there is provided a redundant wiring that electrically connects one portion to an other portion of the signal line so as to be short-circuited.

22. The active matrix substrate as set forth in claim 21, wherein the redundant wiring is formed by using same material and process as in the pixel electrode.

23. The active matrix substrate as set forth in claim 13, wherein there are provided scanning-line-drawing wires, provided along a disposing direction of the signal lines, that are electrically connected to the scanning line.

24. An active matrix substrate constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line,
the active matrix substrate comprising (a) a first layer having the scanning line, the signal lines, and the switching element, and (b) a second layer having the pixel electrodes, aligned along a disposing direction of the signal lines, which are insulated from (i) a scanning-line-side terminal and a signal-line-side terminal of the switching element, (ii) the scanning line, and (iii) the signal lines, the second layer being provided above the first layer, wherein
between the first layer and the second layer, there is provided a connection section for electrically connecting each of the pixel electrodes to a pixel-electrode-side terminal of the switching element that corresponds to the pixel electrode.

25. The active matrix substrate as set forth in claim 24, wherein in the unit pixel, the signal lines are unevenly distributed so that a center of the pixel electrode in a direction of the scanning line is a borderline.

26. The active matrix substrate as set forth in claim 25, wherein the signal lines disposed in the unit pixel exist at only one area of two areas divided by the border line.

27. The active matrix substrate as set forth in claim 24, wherein in the unit pixel, at least one of the signal lines is superposed with all the pixel electrodes in a flat manner via the interlayer insulating film that is provided on the scanning line, the signal lines, and the switching elements.

28. The active matrix substrate as set forth in claim 24, wherein at least one of the signal lines provided in the unit pixel is positioned so as not to be superposed with the pixel electrodes.

29. The active matrix substrate as set forth in claim 24, wherein the switching element is superposed with each of the pixel electrodes that corresponds to the switching element.

30. The active matrix substrate as set forth in claim 24, wherein in the unit pixel,
each of the pixel electrodes other than the one closest to the scanning line is electrically connected to the scanning line via a wire provided under those pixel electrodes intervening between that pixel electrode and the scanning line, and
the pixel electrode provided further from the scanning line has a shorter length in a direction of the signal line so that all the pixel electrodes will have same aperture ratios.

31. The active matrix substrate as set forth in claim 24, wherein:
at least two of the signal lines in the unit pixel are disposed on one-end portion of the unit pixel in a direction of the scanning line so as not to be superposed with the pixel electrodes, and
each of the signal lines, connected to each of the pixel electrodes so as to sandwich those signal lines intervening between the signal line and the pixel electrode, is connected to the switching element via a bypass electrode that bridges the signal lines.

32. The active matrix substrate as set forth in claim 31, wherein the bypass electrode is formed by using same material and process as in the pixel electrode.

33. The active matrix substrate as set forth in claim 24, wherein there is provided a redundant wiring that electrically connects one portion to an other portion of the signal line so as to be short-circuited.

34. The active matrix substrate as set forth in claim 33, wherein the redundant wiring is formed by using same material and process as in the pixel electrode.

35. The active matrix substrate as set forth in claim 24, wherein there are provided scanning-line-drawing wires, provided along a disposing direction of the signal lines, that are electrically connected to the scanning line.

36. An active matrix substrate comprising a plurality of unit pixels disposed in a matrix manner, wherein
each of the unit pixels includes at least:
a scanning line disposed along a first direction;
a plurality of signal lines disposed along a second direction which crosses the first direction;
a plurality of switching elements, connected to the scanning line, which are provided so as to correspond to the respective signal lines;
an interlayer insulating film that is provided on the scanning line, the signal lines, and the switching elements;
a plurality of pixel electrodes that are made ON/OFF by the switching elements so as to or not to conduct to the signal lines; and
a plurality of contact holes, provided in the interlayer insulating film so as to correspond to the respective pixel electrodes, which connect the switching elements to the pixel electrodes, wherein
a distance between the contact holes and the scanning line is different for each of the contact holes in the unit pixel.

37. The active matrix substrate as set forth in claim 36, wherein in the unit pixel, the signal lines are unevenly distributed so that a center of the pixel electrode in a direction of the scanning line is a borderline.

38. The active matrix substrate as set forth in claim 37, wherein the signal lines disposed in the unit pixel exist at only one area of two areas divided by the border line.

39. The active matrix substrate as set forth in claim 36, wherein in the unit pixel, at least one of the signal lines is superposed with all the pixel electrodes in a flat manner via the interlayer insulating film that is provided on the scanning line, the signal lines, and the switching elements.

40. The active matrix substrate as set forth in claim 36, wherein at least one of the signal lines provided in the unit pixel is positioned so as not to be superposed with the pixel electrodes.

41. The active matrix substrate as set forth in claim 36, wherein the switching element is superposed with each of the pixel electrodes that corresponds to the switching element.

42. The active matrix substrate as set forth in claim 36, wherein in the unit pixel,
each of the pixel electrodes other than the one closest to the scanning line is electrically connected to the scanning line via a wire provided under those pixel electrodes intervening between that pixel electrode and the scanning line, and
the pixel electrode provided further from the scanning line has a shorter length in a direction of the signal line so that all the pixel electrodes will have same aperture ratios.

43. The active matrix substrate as set forth in claim 36, wherein:
at least two of the signal lines in the unit pixel are disposed on one-end portion of the unit pixel in a direction of the scanning line so as not to be superposed with the pixel electrodes, and
each of the signal lines, connected to each of the pixel electrodes so as to sandwich those signal lines intervening between the signal line and the pixel electrode, is connected to the switching element via a bypass electrode that bridges those signal lines.

44. The active matrix substrate as set forth in claim 43, wherein the bypass electrode is formed by using same material and process as in the pixel electrode.

45. The active matrix substrate as set forth in claim 36, wherein there is provided a redundant wiring that electrically connects one portion to an other portion of the signal line so as to be short-circuited.

46. The active matrix substrate as set forth in claim 45, wherein the redundant wiring is formed by using same material and process as in the pixel electrode.

47. The active matrix substrate as set forth in claim 36, wherein there are provided scanning-line-drawing wires, provided along a disposing direction of the signal lines, that are electrically connected to the scanning line.

48. A display device in which active matrix substrates are combined with each other as display panels in a disposing direction of a scanning line, each of the active matrix substrates being constituted of unit pixels each of which is provided on a crossing point between a scanning line and each of signal lines in a matrix manner via each of switching elements, the unit pixel including pixel electrodes and the signal lines that correspond to the pixel electrodes, the pixel electrodes and the signal lines conducting when the switching element is ON by applying a scanning signal to the scanning line,
the active matrix substrate comprising at least (a) a first layer having a connection electrode constituted of an extended portion of a pixel-electrode-side terminal of the switching element, and (b) a second layer having the pixel electrodes aligned along a disposing direction of the signal lines, wherein
between the first layer and the second layer, there is provided an interlayer insulating film for insulating the first and second layers from each other, and in the interlayer insulating film, there is provided a connection section for electrically connecting each of the pixel electrodes of the second layer to the connection electrode of the first layer, wherein
the pixel electrodes in the unit pixel correspond to respective colors for color display.

49. The display device as set forth in claim 48, wherein in the unit pixel adjacent to a connection edge of each of the display panels, the signal lines disposed in the unit pixel exist at only one side positioned away from the connection edge so that a center of the pixel electrodes in a direction of the scanning line is a border line.

50. A display device in which active matrix substrates are combined with each other as display panels in a disposing direction of a scanning line, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line, wherein
in the unit pixel, there are provided the pixel electrodes along a disposing direction of the signal lines, and at least two of the signal lines are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges those signal lines, wherein
the pixel electrodes in the unit pixel correspond to respective colors for color display.

51. The display device as set forth in claim 50, wherein in the unit pixel adjacent to a connection edge of each of the display panels, the signal lines disposed in the unit pixel exist at only one side positioned away from the connection edge so that a center of the pixel electrodes in a direction of the scanning line is a border line.

52. A display device in which active matrix substrates are combined with each other as display panels in a disposing direction of a scanning line, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line,
the active matrix substrate comprising (a) a first layer having the scanning line, the signal lines, and the switching element, and (b) a second layer having the pixel electrodes, aligned along a disposing direction of the signal lines, which are insulated from (i) a scanning-line-side terminal and a signal-line-side terminal of the switching element, (ii) the scanning line, and (iii) the signal lines, the second layer being provided above the first layer, wherein
between the first layer and the second layer, there is provided a connection section for electrically connecting each of the pixel electrodes to a pixel-electrode-side terminal of the switching element that corresponds to the pixel electrode, wherein
the pixel electrodes in the unit pixel correspond to respective colors for color display.

53. The display device as set forth in claim 52, wherein in the unit pixel adjacent to a connection edge of each of the display panels, the signal lines disposed in the unit pixel exist at only one side positioned away from the connection edge so that a center of the pixel electrodes in a direction of the scanning line is a border line.

54. A display device in which active matrix substrates are combined with each other as display panels in a disposing direction of a scanning line, each of the active matrix substrates comprising a plurality of unit pixels disposed in a matrix manner, wherein
each of the unit pixels includes at least:
a scanning line disposed along a first direction;
a plurality of signal lines disposed along a second direction which crosses the first direction;
a plurality of switching elements, connected to the scanning line, which are provided so as to correspond to the respective signal lines;
an interlayer insulating film that is provided on the scanning line, the signal lines, and the switching elements;
a plurality of pixel electrodes that are made ON/OFF by the switching elements so as to or not to conduct to the signal lines; and
a plurality of contact holes, provided in the interlayer insulating film so as to correspond to the respective pixel electrodes, which connect the switching elements to the pixel electrodes, wherein
a distance between the contact holes and the scanning lines is different for each of the contact hole in the unit pixel, wherein
the pixel electrodes in the unit pixel correspond to respective colors for color display.

55. The display device as set forth in claim 54, wherein in the unit pixel adjacent to a connection edge of each of the display panels, the signal lines disposed in the unit pixel exist at only one side positioned away from the connection edge so that a center of the pixel electrodes in a direction of the scanning line is a border line.

56. A display device comprising: one or more active matrix substrates; one or more counter substrates; and one or more display media provided between the active matrix substrates and the counter substrates, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line,
the active matrix substrate including at least (a) a first layer having a connection electrode constituted of an extended portion of a pixel-electrode-side terminal of the switching element, and (b) a second layer having the unit pixel in which the pixel electrodes are aligned along a disposing direction of the signal lines, wherein
between the first layer and the second layer, there is provided an interlayer insulating film for insulating the first and second layers from each other, and in the interlayer insulating film, there is provided a connection section for electrically connecting each of the pixel electrodes of the second layer to the connection electrode of the first layer, wherein
the pixel electrodes in the unit pixel correspond to respective colors for color display, wherein
in a case where the active matrix substrates are provided in plurality, the active matrix substrates are connected to each other in a disposing direction of the scanning line, and in a case where the counter substrates are provided in plurality, the counter substrates are connected to each other in the disposing direction of the scanning line, and the pixel electrodes in the unit pixel correspond to respective colors for color display, the active matrix substrates and/or the counter substrates being provided in plurality.

57. The display device as set forth in claim 56, wherein in the unit pixel adjacent to a connection edge of each of the display panels, the signal lines disposed in the unit pixel exist at only one side positioned away from the connection edge so that a center of the pixel electrodes in a direction of the scanning line is a border line.

58. A display device comprising: one or more active matrix substrates; one or more counter substrates; and one or more display media provided between the active matrix substrates and the counter substrates, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line, wherein
in the unit pixel, there are provided the pixel electrodes along a disposing direction of the signal lines, and at least two of the signal lines are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges those signal lines, wherein
in a case where the active matrix substrates are provided in plurality, the active matrix substrates are connected to each other in a disposing direction of the scanning line, and in a case where the counter substrates are provided in plurality, the counter substrates are connected to each other in the disposing direction of the scanning line, and the pixel electrodes in the unit pixel correspond to respective colors for color display, the active matrix substrates and/or the counter substrates being provided in plurality.

59. The display device as set forth in claim 58, wherein in the unit pixel adjacent to a connection edge of each of the display panels, the signal lines disposed in the unit pixel exist at only one side positioned away from the connection edge so that a center of the pixel electrodes in a direction of the scanning line is a border line.

60. A display device comprising: one or more active matrix substrates; one or more counter substrates; and one or more display media provided between the active matrix substrates and the counter substrates, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line,
the active matrix substrate including (a) a first layer having the scanning line, the signal lines, and the switching element, and (b) a second layer having the pixel electrodes, aligned along a disposing direction of the signal lines, which are insulated from (i) a scanning-line-side terminal and a signal-line-side terminal of the switching element, (ii) the scanning line, and (iii) the signal lines, the second layer being provided above the first layer, wherein
between the first layer and the second layer, there is provided a connection section for electrically connecting each of the pixel electrodes to a pixel-electrode-side terminal of the switching element that corresponds to the pixel electrode, wherein
the pixel electrodes in the unit pixel correspond to respective colors for color display, wherein
in a case where the active matrix substrates are provided in plurality, the active matrix substrates are connected to each other in a disposing direction of the scanning line, and in a case where the counter substrates are provided in plurality, the counter substrates are connected to each other in the disposing direction of the scanning line, and the pixel electrodes in the unit pixel correspond to respective colors for color display, the active matrix substrates and/or the counter substrates being provided in plurality.

61. The display device as set forth in claim 60, wherein in the unit pixel adjacent to a connection edge of each of the display panels, the signal lines disposed in the unit pixel exist at only one side positioned away from the connection edge so that a center of the pixel electrodes in a direction of the scanning line is a border line.

62. A display device comprising: one or more active matrix substrates; one or more counter substrates; and one or more display media provided between the active matrix substrates and the counter substrates, each of the active matrix substrates including a plurality of unit pixels disposed in a matrix manner, wherein
each of the unit pixels has at least:
a scanning line disposed along a first direction;
a plurality of signal lines disposed along a second direction which crosses the first direction;
a plurality of switching elements, connected to the scanning line, which are provided so as to correspond to the respective signal lines;
an interlayer insulating film that is provided on the scanning line, the signal lines, and the switching elements;
a plurality of pixel electrodes that are made ON/OFF by the switching elements so as to or not to conduct to the signal lines; and
a plurality of contact holes, provided in the interlayer insulating film so as to correspond to the respective pixel electrodes, which connect the switching elements to the pixel electrodes, wherein
a distance between the contact holes and the scanning lines is different for each of the contact holes in the unit pixel, wherein
in a case where the active matrix substrates are provided in plurality, the active matrix substrates are connected to each other in a disposing direction of the scanning line, and in a case where the counter substrates are provided in plurality, the counter substrates are connected to each other in the disposing direction of the scanning line, and the pixel electrodes in the unit pixel correspond to respective colors for color display, the active matrix substrates and/or the counter substrates being provided in plurality.

63. The display device as set forth in claim 62, wherein in the unit pixel adjacent to a connection edge of each of the display panels, the signal lines disposed in the unit pixel exist at only one side positioned away from the connection edge so that a center of the pixel electrodes in a direction of the scanning line is a border line.

64. A detector in which active matrix substrates are combined with each other as color detection panels in a disposing direction of a scanning line, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line,
the active matrix substrate comprising at least (a) a first layer having a connection electrode constituted of an extended portion of a pixel-electrode-side terminal of the switching element, and (b) a second layer having the pixel electrodes aligned along a disposing direction of the signal lines, wherein
between the first layer and the second layer, there is provided an interlayer insulating film for insulating the first and second layers from each other, and in the interlayer insulating film, there is provided a connection section for electrically connecting each of the pixel electrodes of the second layer to the connection electrode of the first layer, wherein
the pixel electrodes in the unit pixel correspond to respective colors for color detection.

65. A detector in which active matrix substrates are combined with each other as color detection panels in a disposing direction of a scanning line, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line, wherein
in the unit pixel, there are provided the pixel electrodes along a disposing direction of the signal lines, and at least two of the signal lines are disposed on one-end portion of the unit pixel in a direction of the scanning line so as not to be superposed with the pixel electrodes, and each of the signal lines, connected to each of the pixel electrodes so as to sandwich those signal lines intervening between the signal line and the pixel electrode, is connected to the switching element via a bypass electrode that bridges those signal lines, wherein
the pixel electrodes in the unit pixel correspond to respective colors for color display.

66. A detector in which active matrix substrates are combined with each other as color detection panels in a disposing direction of a scanning line, each of the active matrix substrates being constituted of unit pixels each of which is provided on a crossing point between a scanning line and each of signal lines in a matrix manner via each of switching elements, the unit pixel including pixel electrodes which conduct in combination with the signal lines that correspond to the pixel electrodes when the switching element is ON by applying a scanning signal to the scanning line,
the active matrix substrate comprising (a) a first layer having the scanning line, the signal lines, and the switching element, and (b) a second layer having the pixel electrodes, aligned along a disposing direction of the signal lines, which are insulated from (i) a scanning-line-side terminal and a signal-line-side terminal of the switching element, (ii) the scanning line, and (iii) the signal lines, the second layer being provided above the first layer, wherein
between the first layer and the second layer, there is provided a connection section for electrically connecting each of the pixel electrodes to a pixel-electrode-side terminal of the switching element that corresponds to the pixel electrode, wherein
the pixel electrodes in the unit pixel correspond to respective colors for color detection.

67. A detector in which active matrix substrates are combined with each other as color detection panels in a disposing direction of a scanning line, each of the active matrix substrates including a plurality of unit pixels disposed in a matrix manner, wherein
each of the unit pixels includes at least:
a scanning line disposed along a first direction;
a plurality of signal lines disposed along a second direction which crosses the first direction;
a plurality of switching elements, connected to the scanning line, which are provided so as to correspond to the respective signal lines;
an interlayer insulating film that is provided on the scanning line, the signal lines, and the switching elements;
a plurality of pixel electrodes that are made ON/OFF by the switching elements so as to or not to conduct to the signal lines; and
a plurality of contact holes, provided in the interlayer insulating film so as to correspond to the respective pixel electrodes, which connect the switching elements to the pixel electrodes, wherein
a distance between the contact holes to the scanning lines is different for each of the contact holes in the unit pixel, wherein
the pixel electrodes in the unit pixel correspond to respective colors for color detection.
